(19) United States
(12) Patent Application Publication
(10) Pub. No.: US 2023/0180184 A1
(43) Pub. Date: Jun. 8, 2023

(54) DATA SCHEDULING COLLISION AVOIDANCE AND PRIORITY BASED RESOURCE SELECTION WITH DECOUPLED SIDELINK CONTROL AND DATA

(71) Applicant: QUALCOMM Incorporated, San Diego, CA (US)

(72) Inventors: Chih-Hao Liu, San Diego, CA (US); Jing Sun, San Diego, CA (US); Yisheng Xue, San Diego, CA (US); Xiaoxia Zhang, San Diego, CA (US)

(21) Appl. No.: 17/545,430

(22) Filed: Dec. 8, 2021

(51) Int. Cl. H04W 72/02; H04W 72/04; H04W 72/12; H04W 72/10

(52) U.S. Cl. CPC H04W 72/02; H04W 72/0446; H04W 72/0406; H04W 72/1263; H04W 72/10

(57) ABSTRACT

Methods, systems, and devices for wireless communications are described. An example method for wireless communication at a first wireless device, such as a user equipment (UE) may include receiving, at the first wireless device, a first sidelink control information (SCI) message from a second wireless device, wherein the first SCI message indicates a scheduling conflict between a first data transmission of the second wireless device and a second data transmission of the first wireless device. The method may also include transmitting a second SCI message from the first wireless device based at least in part on the scheduling conflict between the first data transmission and the second data transmission, wherein the second SCI message indicates a data resource allocation for the second data transmission that mitigates the scheduling conflict.

### FIELD OF TECHNOLOGY

The following relates to wireless communications, including data scheduling collision avoidance and priority based resource selection with decoupled sidelink control and data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may communicate with another UE via a sidelink communications link. For example, a first UE may transmit sidelink transmissions to a second UE. In some implementations, the second UE may be configured to contemporaneously transmit sidelink transmissions to the first UE or to another UE. Techniques for coordinating sidelink transmissions may be improved.

### SUMMARY

The described techniques relate to improved methods, systems, devices, and apparatuses that support data scheduling collision avoidance and priority based resource selection with decoupled sidelink control and data. Generally, the described techniques provide for improved methods of identifying and mitigating a scheduling conflict in sidelink communications between multiple different sidelink transmissions in the same set of channel resources (e.g., time resources, frequency resources, code resources, etc.).

Two or more UEs may transmit sidelink control information (SCI) that each identifies a data resource from a data resource pool for subsequent transmission of data. For example, a first UE may send a first SCI message that uses a first control resource (e.g., a mini-slot of a control resource) that indicates the selected data resource. A second UE may detect and decode the first SCI message and determine that there could be a scheduling conflict between the first UE and the second UE. The second UE may perform one of several conflict mitigation processes to overcome the scheduling conflict.

The mitigation processes may include, for example, regenerating a second SCI message with a non-conflicting data resource. This option may be used when there is enough processing time between detecting the scheduling conflict and when the second UE has to transmit the second SCI message. The mitigation processes may also include selecting an SCI message from a set of SCI messages that have different data resources, wherein the selected SCI message may include a non-conflicting data resource. In other examples, the mitigation processes may include performing a joint re-selection of the data resources.

Alternatively, a time interleave technique is described that ensures that two UEs using different time interleaves of the control resource pool will not have conflicting data resources. The time interleave technique may use traffic or other priority metrics to determine which mini-slot of the control resource slot will be used by which UE.

A method for wireless communication at a first wireless device is described. The method may include receiving, at the first wireless device, a first SCI message from a second wireless device, where the first SCI message indicates a scheduling conflict between a first data transmission of the second wireless device and a second data transmission of the first wireless device. The method may further include transmitting a second SCI message from the first wireless device based on the scheduling conflict between the first data transmission and the second data transmission, where the second SCI message indicates a data resource allocation for the second data transmission that mitigates the scheduling conflict.

An apparatus for wireless communication at a first wireless device is described. The apparatus may include a processor, memory coupled with the processor, and instructions stored in the memory. The instructions may be executable by the processor to cause the apparatus to receive, at the first wireless device, a first SCI message from a second wireless device, where the first SCI message indicates a scheduling conflict between a first data transmission of the second wireless device and a second data transmission of the first wireless device. The instructions may be executable by the processor to cause the apparatus to transmit a second SCI message from the first wireless device based on the scheduling conflict between the first data transmission and the second data transmission, where the second SCI message indicates a data resource allocation for the second data transmission that mitigates the scheduling conflict.

Another apparatus for wireless communication at a first wireless device is described. The apparatus may include means for receiving, at the first wireless device, a first SCI message from a second wireless device, where the first SCI message indicates a scheduling conflict between a first data transmission of the second wireless device and a second data transmission of the first wireless device. The apparatus may further include means for transmitting a second SCI message from the first wireless device based on the scheduling conflict between the first data transmission and the second data transmission, where the second SCI message indicates a data resource allocation for the second data transmission that mitigates the scheduling conflict.

A non-transitory computer-readable medium storing code for wireless communication at a first wireless device is described. The code may include instructions executable by a processor to receive, at the first wireless device, a first SCI message from a second wireless device, where the first SCI message indicates a scheduling conflict between a first data transmission of the second wireless device and a second data transmission of the first wireless device. The code may include instructions executable by a processor to transmit a second SCI message from the first wireless device based on the scheduling conflict between the first data transmission and the second data transmission, where the second SCI message indicates a data resource allocation for the second data transmission that mitigates the scheduling conflict.

In some examples of the method, apparatuses, and non-transitory computer-readable medium described herein, the first SCI message indicates the scheduling conflict may include operations, features, means, or instructions for decoding the first SCI message, where the decoded first SCI message indicates a first data resource for the first data transmission, comparing the first data resource for the first data transmission with a second data resource for the second data transmission, and determining that there may be at least a partial overlap between the first data resource for the first data transmission and the second data resource for the second data transmission.

Some examples of the method, apparatuses, and non-transitory computer-readable medium described herein may further include operations, features, means, or instructions for determining a time period between receiving the first SCI message and a transmission time for the second SCI message.

Some examples of the method, apparatuses, and non-transitory computer-readable medium described herein may further include operations, features, means, or instructions for determining that the time period may be greater than a generation time for generating the second SCI message based on a comparison of the time period with a processing time for generating the second SCI message, selecting a third data resource for the second data transmission based on the second SCI message such that the third data resource for the second data transmission may be non-conflicting with a first data resource for the first data transmission, and generating the second SCI message for the second data transmission based on the third data resource, where the third data resource includes the data resource allocation.

Some examples of the method, apparatuses, and non-transitory computer-readable medium described herein may further include operations, features, means, or instructions for determining that the time period may be greater than a modification time for modifying the second SCI message based on a comparison of the time period with a processing time for modifying the second SCI message, selecting a third data resource for the second data transmission based on the second SCI message such that the third data resource for the second data transmission may be non-conflicting with a first data resource for the first data transmission, and modifying the second SCI message for the second data transmission based on the third data resource, where the third data resource includes the data resource allocation.

Some examples of the method, apparatuses, and non-transitory computer-readable medium described herein may further include operations, features, means, or instructions for comparing the time period with a processing time threshold, determining that the time period may be less than the processing time threshold, and selecting the second SCI message from a set of SCI messages based on the second SCI message indicating the data resource allocation.

Some examples of the method, apparatuses, and non-transitory computer-readable medium described herein may further include operations, features, means, or instructions for comparing the time period with a processing time threshold, determining that the time period may be less than the processing time threshold, and performing a joint resource re-selection for the data resource allocation for the second data transmission.

Some examples of the method, apparatuses, and non-transitory computer-readable medium described herein may further include operations, features, means, or instructions for generating a set of SCI messages with different data resources and selecting the second SCI message from the set of SCI messages based on the second SCI message indicating the data resource allocation.

In some examples of the method, apparatuses, and non-transitory computer-readable medium described herein, the second SCI message may be transmitted in a first radio frequency spectrum band and the second data transmission may be transmitted in a second radio frequency spectrum band and the second radio frequency spectrum band may be different from the first radio frequency spectrum band.

In some examples of the method, apparatuses, and non-transitory computer-readable medium described herein, the second wireless device may have higher priority traffic than the first wireless device.

A method for wireless communication at a wireless device is described. The method may include generating a SCI message, where the SCI message is associated with a time domain interlace of a set of multiple control resources and indicates a data resource for a data transmission based on the time domain interlace. The method may further include transmitting the SCI message in a mini-slot of a control resource of the set of multiple control resources associated with the time domain interlace.

An apparatus for wireless communication at a wireless device is described. The apparatus may include a processor, memory coupled with the processor, and instructions stored in the memory. The instructions may be executable by the processor to cause the apparatus to generate a SCI message, where the SCI message is associated with a time domain interlace of a set of multiple control resources and indicates a data resource for a data transmission based on the time domain interlace. The instructions may be executable by the processor to cause the apparatus to transmit the SCI message in a mini-slot of a control resource of the set of multiple control resources associated with the time domain interlace.

Another apparatus for wireless communication at a wireless device is described. The apparatus may include means for generating a SCI message, where the SCI message is associated with a time domain interlace of a set of multiple control resources and indicates a data resource for a data transmission based on the time domain interlace. The apparatus may further include means for transmitting the SCI message in a mini-slot of a control resource of the set of multiple control resources associated with the time domain interlace.

A non-transitory computer-readable medium storing code for wireless communication at a wireless device is described. The code may include instructions executable by a processor to generate a SCI message, where the SCI message is associated with a time domain interlace of a set of multiple control resources and indicates a data resource for a data transmission based on the time domain interlace. The code may include instructions executable by a processor to transmit the SCI message in a mini-slot of a control resource of the set of multiple control resources associated with the time domain interlace.

Some examples of the method, apparatuses, and non-transitory computer-readable medium described herein may further include operations, features, means, or instructions for selecting the data resource from a slot in a data resource pool, where the slot may be based on the time domain interlace.

Some examples of the method, apparatuses, and non-transitory computer-readable medium described herein may further include operations, features, means, or instructions for selecting a slot segment from a set of multiple slot segments of a control resource pool and selecting the time domain interlace based on the selected slot segment, where the selected slot segment includes the mini-slot.

Some examples of the method, apparatuses, and non-transitory computer-readable medium described herein may further include operations, features, means, or instructions for selecting the mini-slot associated with the time domain interlace based on a priority of traffic.

In some examples of the method, apparatuses, and non-transitory computer-readable medium described herein, the time domain interlace may be associated with a set of mini-slots in the set of multiple control resources in a control subchannel.

A method for wireless communication at a wireless device is described. The method may include receiving a SCI message in a mini-slot of a control resource associated with a time domain interlace and decoding the SCI message, where the SCI message indicates a data resource for a data transmission based on the time domain interlace.

An apparatus for wireless communication at a wireless device is described. The apparatus may include a processor, memory coupled with the processor, and instructions stored in the memory. The instructions may be executable by the processor to cause the apparatus to receive a SCI message in a mini-slot of a control resource associated with a time domain interlace and decode the SCI message, where the SCI message indicates a data resource for a data transmission based on the time domain interlace.

Another apparatus for wireless communication at a wireless device is described. The apparatus may include means for receiving a SCI message in a mini-slot of a control resource associated with a time domain interlace and means for decoding the SCI message, where the SCI message indicates a data resource for a data transmission based on the time domain interlace.

A non-transitory computer-readable medium storing code for wireless communication at a wireless device is described. The code may include instructions executable by a processor to receive a SCI message in a mini-slot of a control resource associated with a time domain interlace and decode the SCI message, where the SCI message indicates a data resource for a data transmission based on the time domain interlace.

Some examples of the method, apparatuses, and non-transitory computer-readable medium described herein may further include operations, features, means, or instructions for receiving the data transmission in the data resource indicated by the SCI message.

### BRIEF DESCRIPTION OF THE DRAWINGS

FIG. 1 illustrates an example of a wireless communications system that supports data scheduling collision avoidance and priority based resource selection with decoupled sidelink control and data in accordance with aspects of the present disclosure.

FIG. 2 illustrates an example of a wireless communications system that supports data scheduling collision avoidance and priority based resource selection with decoupled sidelink control and data in accordance with aspects of the present disclosure.

FIG. 3 illustrates an example of a process flow that supports data scheduling collision avoidance and priority based resource selection with decoupled sidelink control and data in accordance with aspects of the present disclosure.

FIGS. 4 through 8 illustrate example block diagrams that support data scheduling collision avoidance and priority based resource selection with decoupled sidelink control and data in accordance with aspects of the present disclosure.

FIG. 9 illustrates an example of a flowchart that supports data scheduling collision avoidance and priority based resource selection with decoupled sidelink control and data in accordance with aspects of the present disclosure.

FIGS. 10 and 11 show block diagrams of devices that support data scheduling collision avoidance and priority based resource selection with decoupled sidelink control and data in accordance with aspects of the present disclosure.

FIG. 12 shows a block diagram of a communications manager that supports data scheduling collision avoidance and priority based resource selection with decoupled sidelink control and data in accordance with aspects of the present disclosure.

FIG. 13 shows a diagram of a system including a device that supports data scheduling collision avoidance and priority based resource selection with decoupled sidelink control and data in accordance with aspects of the present disclosure.

FIGS. 14 through 16 show flowcharts illustrating methods that support data scheduling collision avoidance and priority based resource selection with decoupled sidelink control and data in accordance with aspects of the present disclosure.

### DETAILED DESCRIPTION

In sidelink communications, two or more UEs may communicate directly with each other. The UEs may determine their own schedules for sidelink transmissions or may be externally instructed regarding scheduling sidelink transmissions. In some examples, two or more UEs may have a scheduling conflict with each other. The conflict could include, for example, a first UE scheduling a data transmission and sending out sidelink control information (SCI) indicating the resources (e.g., time, frequency, resource block, etc.) for the data transmission. In some examples, UEs may be able to support cross carrier scheduling for different frequency bands for sidelink communications. For example, a UE may support cross carrier scheduling for a 6 GHz band and for mmW (e.g., 60 GHz) bands for sidelink communications. For cross carrier scheduling, a UE may transmit control signaling, such as SCI, over one band in order to schedule data transmissions in another band. For example, a UE may transmit SCI in 6 GHz (e.g., via a physical sidelink control channel (PSCCH)) that schedules data transmissions in mmW (e.g., via a physical sidelink shared channel (PSSCH)).

Resource pools for the PSCCH and the PSSCH may be decoupled in order to support beam switching. In some examples, the resource pools may be in different carriers. For example, the control resource pool may be in a 6 GHz band and the data resource pool may be in the 60 GHz band, although in some examples they may be in the same band. For example, the SCI in PSCCH in one band may be used to schedule data transmissions in PSSCH in the other band. In some examples, a UE may transmit SCI in PSCCH in one band to schedule data transmissions in PSSCH in another band, which may conflict with data transmissions in PSSCH for another UE.

Joint channel sensing and resource selection for control and data resource pools are described herein and may be used to mitigate detected scheduling conflicts. A sensing window for a data transmission (e.g., time domain resource allocation (TDRA) or frequency domain resource allocation (FDRA)) may be indicated in a first stage SCI (SCI-1). However, due to half-duplex problems, a UE that is transmitting may not be able to receive or otherwise detect another UE that is also transmitting. Therefore, the UEs may not be able to determine that they have a conflict in the data resource pool. Even if the transmitters choose different control mini-slots in the same control sub-channel, there is chance that the scheduled PSSCHs may collide with each other as the transmitters in different control mini-slots may freely choose their own frequency domain resource allocation (FDRA) in the data resource pool. Techniques described herein provide mechanisms and structures in the control resource pool to enable PSSCH scheduling collision avoidance.

Techniques are described that modify the resource selection procedure in situations where the earlier control mini-slot has a higher scheduling priority. For example, a first transmitter (e.g., UE, IIoT device, etc.) intending to transmit an SCI monitors the mini-slot SCI-1 from other transmitters in the same control sub-channel to detect a scheduling conflict in the data resource pool. If a collision is detected, the first transmitter may re-adjust the FDRA or perform resource re-selection to avoid the conflict. This may include priority based resource selection in the control resource pool, where the transmitter with the higher priority may choose an earlier control mini-slot from the control resource pool. In a first alternative, if processing time allows, the first transmitter may choose a different FDRA or may regenerate the SCI waveform with a non-conflicting FDRA. In a second alternative, if the first transmitter does not have time to modify the FDRA, the first transmitter may perform a joint resource reselection.

In another example, the mini-slots may be divided into a number of time domain interlaces, wherein each interlace in the control resource pool may map to a slot in the data resource pool. With the interlace mapping, the first transmitter may have a number of mini-slots to detect the conflicting FDRA and modify the FDRA within the same slot of the data resource pool. The transmitter with the higher priority traffic may choose the first mini-slot for the control data.

Aspects of the disclosure are initially described in the context of wireless communications systems. Aspects of the disclosure are further illustrated by and described with reference to a process flow, block diagrams, and flowchart. Aspects of the disclosure are further illustrated by and described with reference to apparatus diagrams, system diagrams, and flowcharts that relate to data scheduling collision avoidance and priority based resource selection with decoupled sidelink control and data.

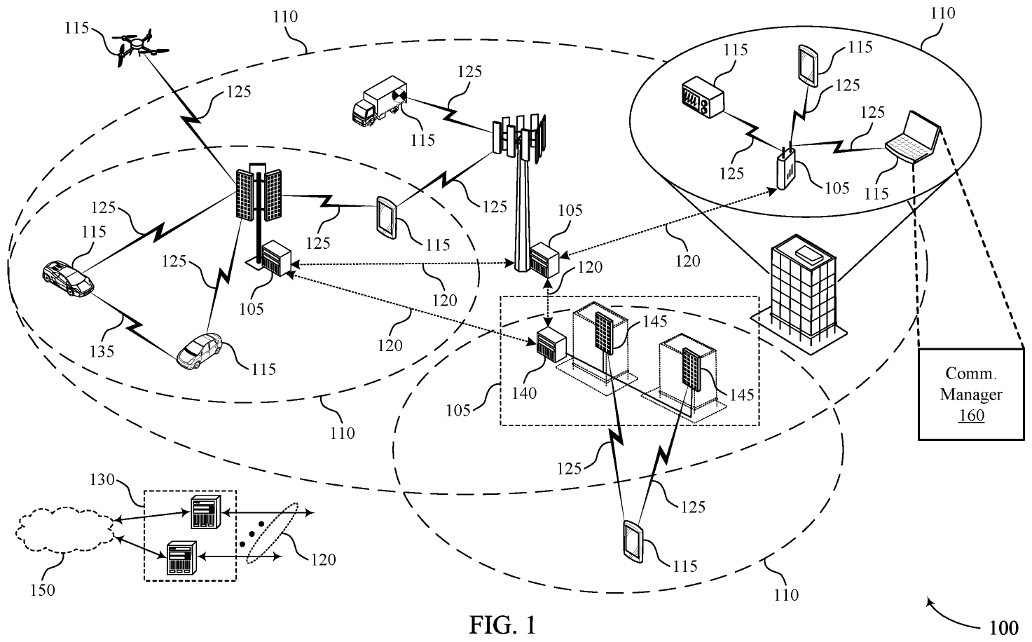

FIG. 1 illustrates an example of a wireless communications system 100 that supports data scheduling collision avoidance and priority based resource selection with decoupled sidelink control and data in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UE 115 may include a communications manager 160, which may support data scheduling collision avoidance and priority based resource selection with decoupled sidelink control and data. In some examples, the communications manager 160 may receive, at the first wireless device, a first sidelink control information message from a second wireless device, wherein the first sidelink control information message indicates a scheduling conflict between a first data transmission of the second wireless device and a second data transmission of the first wireless device. The communications manager 160 may transmit a second sidelink control information message from the first wireless device based at least in part on the scheduling conflict between the first data transmission and the second data transmission, wherein the second sidelink control information message indicates a data resource allocation for the second data transmission that mitigates the scheduling conflict.

In another example, the communications manager 160 may generate a sidelink control information message, wherein the sidelink control information message is associated with a time domain interlace of a plurality of control resources and indicates a data resource for a data transmission based at least in part on the time domain interlace. The communications manager 160 may transmit the sidelink control information message in a mini-slot of a control resource of the plurality of control resources associated with the time domain interlace.

In another example, the communications manager 160 may receive a sidelink control information message in a mini-slot of a control resource associated with a time domain interlace. The communications manager 160 may decode the sidelink control information message, wherein the sidelink control information message indicates a data resource for a data transmission based at least in part on the time domain interlace.

The techniques described herein enable a UE that has resources scheduled for sidelink transmissions to become aware of possible conflicts with sidelink transmissions from another UE. The UE may detect the scheduling conflict with the other UE by decoding SCI from the other UE. The UE may avoid the scheduling conflict in the future data transmission by changing the resources used to resources that do not conflict. The techniques described herein improve network efficiency through more efficient utilization of communication resources, reduce interference, reduce retransmissions, reduce power consumption leading to a longer battery life due to less retransmissions, and improve user experience. The described techniques may also improve communication reliability, improve coordination between devices, and reduce latency.

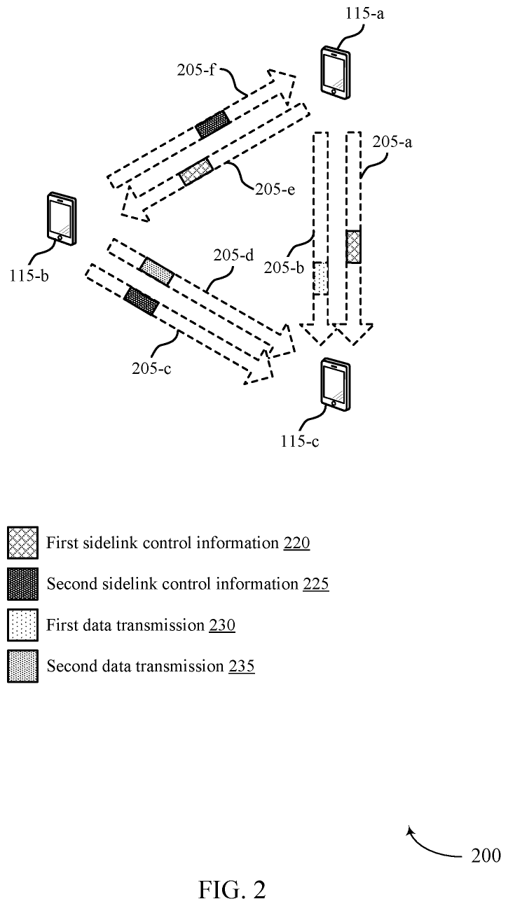

FIG. 2 illustrates an example of a wireless communications system 200 that supports data scheduling collision avoidance and priority based resource selection with decoupled sidelink control and data in accordance with aspects of the present disclosure. The wireless communications system 200 may include a first UE 115-a, a second UE 115-b, and a third UE 115-c that may be examples of one or more aspects of a UE 115 as described herein. As described with respect to the example of FIG. 2, the first UE 115-a, the second UE 115-b, and the third UE 115-c may be collectively referred to as UEs 115. UEs 115 may each be served by a base station, where the UEs 115 may be served by the same base station or different base stations. In some cases, UEs 115-a, 115-b, 115-c, or a combination thereof may implement techniques described herein for collision avoidance.

In SCI-1 (a legacy SCI format), a UE 115 can reserve resources for up to three retransmissions in a periodic pattern. The period can be indicated in the SCI-1 and have values that range from 1-99 slots, up to 100, 200, . . . , 1000, for example. A value of 0 indicates there is no periodic reservation. The SCI-1 can be RRC configured to reserve up to one or two additional slots within 32 slots of the first transmission.

A node (e.g., transmitter) can be triggered to report available resources to the upper layers of the node. The information may come from historic SCI-1 monitoring by taking into consideration the resource reserved and the priority of the monitored SCI-1. For a monitored SCI-1, the node may reserve the resource from the current transmission up to three transmissions (two remaining ones) and up to three resources in the next instance of the indicated period (e.g., if a non-zero period is indicated).

In an example where a node cannot monitor the control channel due to a half-duplex restriction, the node may assume the worst case (e.g., that there is an SCI-1 transmitted in the slot that is not detected) and may block the slots possibly indicated by all of the configured periods. The node may block up to fifteen slots, for example. Techniques described herein provide scheduling conflict resolutions for NR frequency range 1 (FR1) (e.g., 410-7,125 MHz), where sidelink transmissions may be scheduled (e.g., sidelink resources may be scheduled).

These techniques may be extended to cross carrier scheduling, for example, to 6 GHz for an Intelligent Transport System (ITS) band and 60 GHz for mmW. Control signaling may be carried in the legacy ITS band with the data transmissions provided by a cross carrier scheduling design for a data channel in mmW. The resource pool and the data resource pool may be decoupled from each other, where the decoupled control resource pool can fit into the 6 GHz band and the decoupled data resource pool can fit into the 60 GHz band. As used herein, decoupled resource pools indicate that the resource pools are in different bands. In other examples, other frequency bands for the resource pools may be used. In some examples, the control information and the data are transmitted in the same carrier but in different bands. In other examples, the control information and the data may be transmitted in the same band but different carriers. In some examples, the control information and the data are transmitted in different carriers and different bands.

The decoupled resource pool design may also support NR frequency range 2 (FR2) (e.g., 24,250-52,600 MHz). In FR2, the control data and the data transmission may not be in the same slot because in mmW, there is a k0 timing offset between the control resource pool and the scheduling data which needs to be greater than zero slots. The k0 timing offset could be 1, 2, or 3 slots depending on the UE capability, for example. Therefore, the control information may be sent in one slot, and the data transmission may be sent in later slots based at least in part on the offset.

In some wireless communications systems, such as wireless communications system 200, a UE 115 may communicate with one or more other UEs 115 via sidelink communication links 205, such as sidelink communication links 205-a through 205-f. For example, the first UE 115-a may transmit SCI 220 via sidelink communications link 205-a (e.g., via a sidelink control channel signal, such as a physical sidelink control channel (PSCCH)) to the third UE 115-c and to the second UE 115-b via sidelink communications link 205-e (e.g., also via PSCCH). The transmissions may be broadcast or unicast (e.g., beamformed towards the intended recipients). The UEs 115 may be intended to communicate with the other UEs 115 or may even be communicating with different UEs, but the UEs 115 may receive some or all of the sidelink transmissions.

The SCI 220 may include sidelink control information (e.g., a first-stage SCI) that may indicate information (e.g., time resource, frequency resources, MCS, etc.) associated with a subsequent sidelink transmission, a first data transmission 230 (e.g., via a physical sidelink shared channel (PSSCH)). The UE 115-a may transmit the SCI 220, and the UE 115-b and the UE 115-c may receive the SCI 220. The UE 115-b and the UE 115-c may decode the SCI and determine the resources to be used for an upcoming data transmission by the UE 115-a. For example, the UE 115-a may transmit the first data transmission 230 using the resources identified in the SCI 220.

One or more of the UEs, such as the UE 115-b, may also have data for transmission over a sidelink channel. For example, the UE 115-b may have selected a data resource for a second data transmission 235 to the UE 115-c, and may have generated an SCI for the UE 115-c to identify the resources for the second data transmission 235. However, upon decoding the first SCI 220, the UE 115-b may identify a scheduling conflict between the first data transmission 230 and the second data transmission 235. Based on this scheduling conflict, the UE 115-b may use one of several different techniques for avoiding the scheduling conflict.

For example, the UE 115-b may select a different data resource from the data resource pool and update the SCI to reflect the new data resource. The UE 115-b may use this technique if there is sufficient processing time between decoding the first SCI 220 and when the UE 115-b needs to transmit the second SCI 225. If there is insufficient time, the UE 115-b may select an SCI message from a set of pre-generated SCI messages, wherein the SCI message identifies a data resource that does not conflict with the data resource scheduled for the UE 115-a. The set of pre-generated SCI messages may include SCI messages indicating different data resources from the data resource pool. In another example, the second SCI 235 may be selected based on an interleaving mechanism between the control resource pool and the data resource pool. As used herein, the phrase “a set” shall be construed as including the possibility of a set with one member. That is, the phrase “a set” shall be construed in the same manner as “one or more.”

The techniques described herein improve network efficiency through more efficient utilization of communication resources because the UEs are less likely to transmit sidelink messages when they conflict with other sidelink messages. This may also reduce interference, reduce retransmissions, and reduce power consumption leading to a longer battery life due to less retransmissions. The described techniques may also improve communication reliability, improve coordination between devices, and reduce latency.

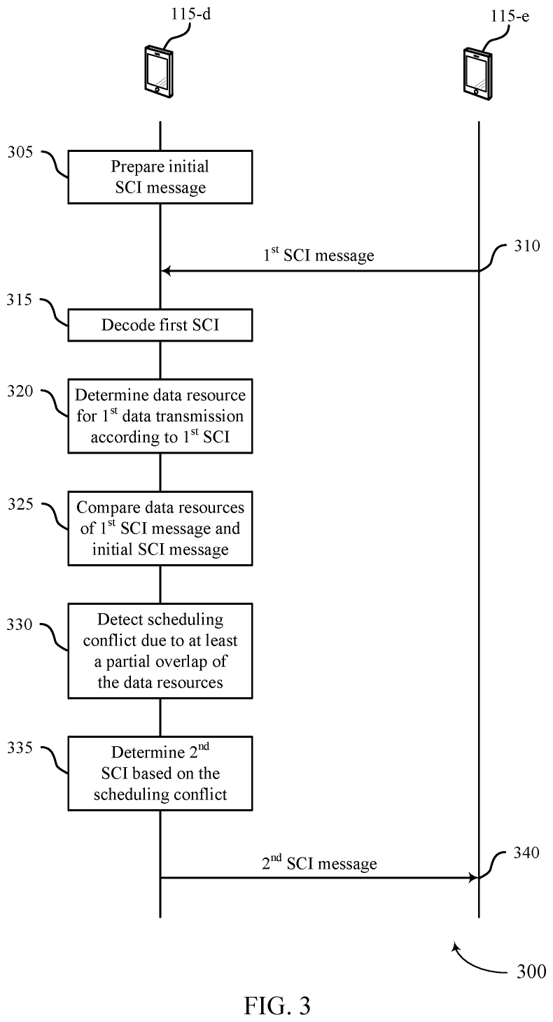

FIG. 3 illustrates an example of a process flow 300 that supports data scheduling collision avoidance and priority based resource selection with decoupled sidelink control and data in accordance with aspects of the present disclosure. In some examples, the process flow 300 may implement aspects of wireless communications system 100 or wireless communications system 200. The process flow 300 may include a first UE 115-d and a second UE 115-e, which may be examples of one or more aspects of the UEs 115 as described herein.

At 305, the first UE 115-d may prepare an initial SCI message. The initial SCI message may indicate control information regarding a subsequent data transmission. For example, the initial SCI message may be prepared for transmission using a control resource from the available control resource pool. The initial SCI message may indicate a second data resource from a data resource pool that is intended for data transmission.

In some examples, the UE 115-d may prepare a set of SCI messages, wherein each SCI message indicates different data resources. If there happens to be insufficient time for the UE 115-d to prepare an updated SCI message when a scheduling conflict is detected, the UE 115-d may select an already prepared SCI message from the set that does not conflict with the data transmission of another UE.

At 310, the UE 115-e may transmit a first SCI message, which may be received by the UE 115-d. The first SCI message may be transmitted on a first control resource and indicate a first data resource for a subsequent data transmission.

At 315, the UE 115-d may decode the first SCI message. At 320, the UE 115-d may determine the first data resource from the decoded message. At 325, the UE 115-d may compare the first data resource to the second data resource of the initial SCI message. The comparison may be, for example, a comparison of the time and frequency resources of the first data resource and the second data resource to determine if there is at least a partial overlap. For example, the first data resource may overlap frequencies for at least part of a time period, such as a time slot.

At 330, the UE 115-d may detect a scheduling conflict based at least in part on the comparison. For example, the first SCI message may indicate a scheduling conflict between the first data transmission of the UE 115-e and a second data transmission of the UE 115-d in the initial SCI message, based on the first data resource for the first data transmission at least partially overlapping with a second data resource for the second data transmission.

In examples where the set of SCI messages is prepared, the UE 115-d may compare the first data resource to the data resources identified in the set of SCI messages, to exclude those SCI messages that have a data resource that at least partially overlaps with the first data resource from consideration for selection as the second SCI message.

At 335, the UE 115-d may determine a second SCI message based on the detection of the scheduling conflict, such that a data resource indicated in the second SCI message for the subsequent data transmission does not conflict or overlap with the first data resource. The UE 115-d may have several different techniques for determining the second SCI message. First, if there is sufficient time to perform processing, the UE 115-d may modify the initial SCI message to include a different data resource from the data resource pool that does not conflict with the first data resource. Alternatively, if the UE 115-d has already determined a set of SCI messages, the UE 115-d may select an SCI message from the set that does not conflict with the first data resource. The selection from the set of SCI messages that do not conflict with the first data resource may be further decided based on other factors, such as, for example, priority, an earlier or alter data resource, other received SCI messages, and the like. In some examples, the set of SCI messages includes an SCI message for each available data resource. In other examples, the set of SCI messages includes two SCI messages that indicate data resources that could not both overlap with a conflicting data resource. In other examples, other numbers of SCI messages may be included in the set.

In some examples, the UE 115-d may perform a joint resource re-selection for the data resource allocation for the second data transmission. In other examples, if there is sufficient time between detecting the scheduling conflict and when the UE 115-d needs to transmit the second SCI message, the UE 115-d may generate the second SCI message by choosing a data resource from the data resource pool that does not conflict.

Regardless of how the second SCI message is determined, the UE 115-d may transmit the second SCI message at 340. The UE 115-d may transmit the second SCI message to a particular UE (which may or may not be UE 115-e in various examples), to more than one UE, in a particular direction with no specific intended recipient, or broadcasted, for example.

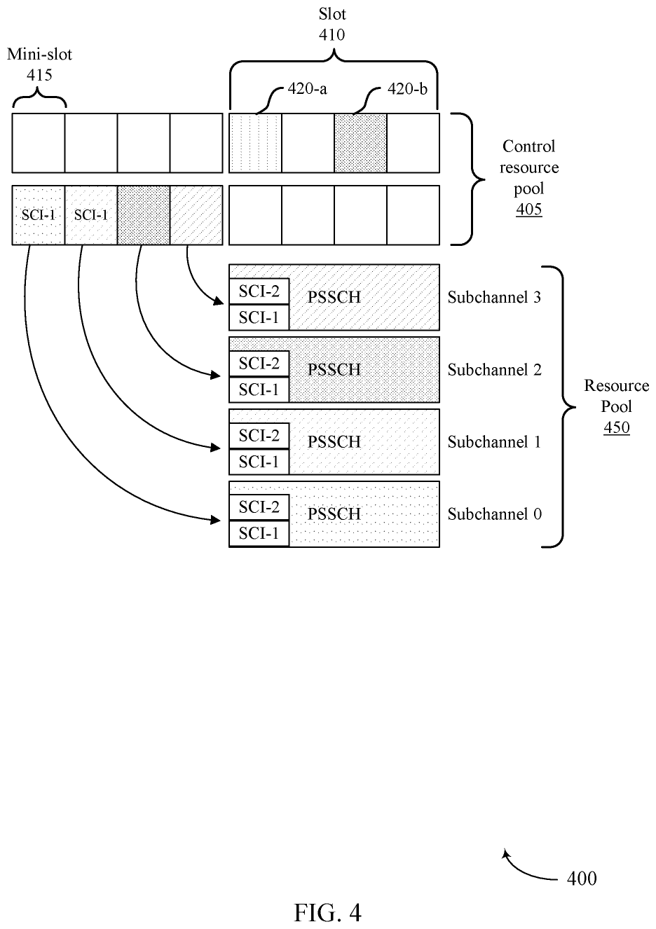

FIG. 4 illustrates an example of a block diagram 400 that supports data scheduling collision avoidance and priority based resource selection with decoupled sidelink control and data in accordance with aspects of the present disclosure. The block diagram 400 shows a control resource pool 405 and a data resource pool 450. The block diagram 400 may illustrate mapping between different control resources from the control resource pool 405 and different data resources from the data resource pool 450. The block diagram 400 may illustrate sidelink support for cross carrier scheduling for 6 GHz and mmW (e.g. 60 GHz). A wireless device, such as a UE, may send control signaling (e.g., SCI) in 6 GHz to schedule PSSCH in mmW.

The control resource pool 405 may include a plurality of slots 410 which comprise mini-slots 415. The control resource pool 405 may be comprise PSCCH resources. The data resource pool 450 may be a legacy data resource pool. The data resource pool 450 may include subchannel 0 through subchannel 3. The shading represented in some of the mini-slots 415 and the data resource pool 450 are to help distinguish between neighboring mini-slots 415 and for ease of seeing which resources map together. The control resource pool 405 shows two subchannels.

In some examples, broadcasting SCI-1 messages contain future reservations that other nodes need to respect may be suitable in low band carrier for improved coverage. In some examples, directional reservation may be possible. Decoupled PSCCH and PSSCH resource pool design support control/data beam switching and cross carrier scheduling. Control and data channels are decoupled to support beam switching. Techniques described herein support cross carrier scheduling. For example, the mini-slots 415 may correspond to control resource pools 405 in a low band and the data resource pool 450 may be in a high band. Mini-slot SCI-1 messages reduce the scheduling delay in low band to match the PSSCH in high band numerology.

SCI-1 messages (e.g., legacy SCI) may be sent in a mini-slot of the control resource pool, which maps to a particular data resource pool subchannel. The SCI-1 message may include an indication of the mapping to the data resource pool subchannel. SCI-2 messages may be non-legacy SCI messages, and may be used with cross carrier scheduling for two different carriers or frequency bands.

In some examples, a node with critical information may send an SCI message more than once. For example, a transmitter with a critical transport block may send repetitive SCI in mini-slots 420-a and 420-b. The repetitive transmission of the control information may increase the chance that the transport block will be received.

If an SCI message indicates that it maps to the same data resource from the data resource pool 450 as another SCI message, then a scheduling conflict may occur. Techniques described herein provide ways to mitigate such a potential occurrence.

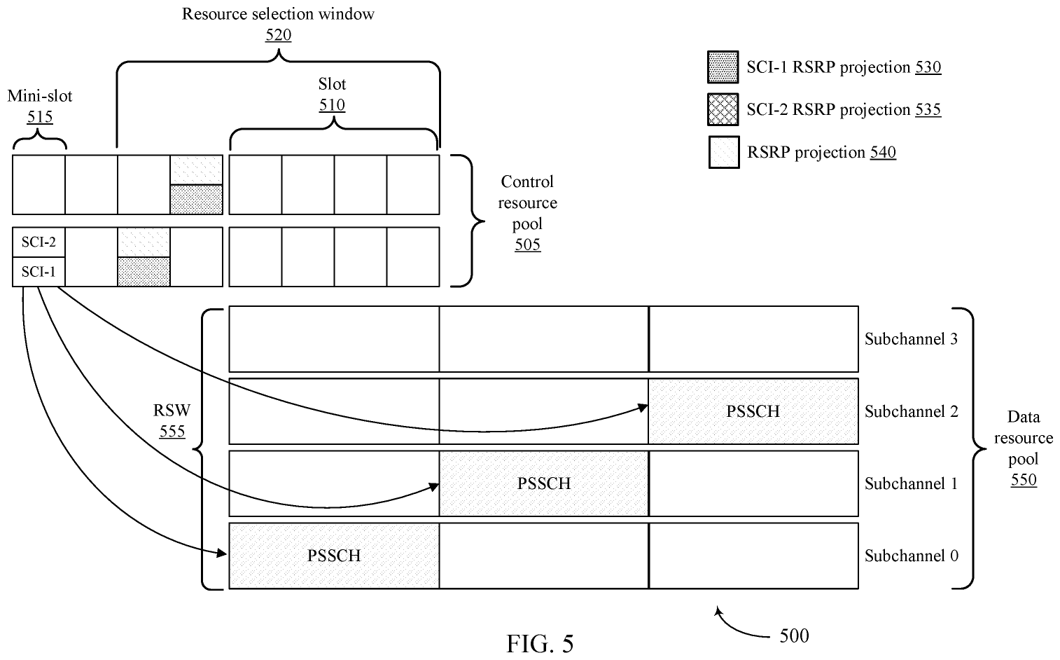

FIG. 5 illustrates an example of a block diagram 500 that supports data scheduling collision avoidance and priority based resource selection with decoupled sidelink control and data in accordance with aspects of the present disclosure. The block diagram 500 shows a control resource pool 505 and a data resource pool 550. The block diagram 500 may illustrate mapping between different control resources from the control resource pool 505 and different data resources from the data resource pool 550. The block diagram 500 may illustrate sidelink support for cross carrier scheduling for 6 GHz and mmW (e.g. 60 GHz). A wireless device, such as a UE, may send control signaling (e.g., SCI) in 6 GHz PSCCH to schedule data transmissions in PSSCH in mmW.

The control resource pool 505 may include a plurality of slots 510 which comprise mini-slots 515. The control resource pool 505 may be comprise PSCCH resources. The control resource pool 505 shows two subchannels. The data resource pool 550 may include four subchannels, subchannel 0 through subchannel 3.

FIG. 5 illustrates an example of joint channel sensing and resource selection. In legacy sidelink systems, a node may perform some channel sensing before it schedules data resources for an upcoming transport block. A purpose of the joint channel sensing may be to sense the SCI which is transmitted by a prior node because the SCI can reserve some future resources for retransmission. Because the retransmission may be critical, the node needs sense within this window so it can avoid scheduling over the resources from the prior node. That is how a legacy system with a single resource pool may work. In examples described herein, both the control resource pool 505 and the data resource pool 550 are independent, so nodes may run joint channel sensing and resource selection in the control resource pool 505 and the data resource pool 550.

A node, such as a UE, may perform sensing during a sensing window of the control resource pool 505. In some examples, the UE may also perform sensing on the data resource pool 550. The sensing window may be based on a SCI-1 received from the prior node. By performing the sensing in the control resource pool 505, the UE can project where the prior node has reserved for re-transmitting the SCI and also may determine the data resources in the data resource pool 550 are reserved for re-transmission as well. The decoupled design described herein may have two sets of the time domain resource allocation (TDRA) and FDRA, one set is to reserve the future resources for reservation for SCI transmissions and the other set of the FDRA/TDRA is for reservations for the upcoming data transmission. There may be resource selection windows (RSW) in both the control resource pool and the data resource pool when the resource pools are decoupled.

For example, a node (e.g., a UE or transmitter) may make resource selections for SCI and PSSCH in a resource selection window 520 for the control resource pool 505 and in a resource selection window 555 for the data resource pool 550. In some examples, an SCI-1 may indicate the TDRA/FDRA of the selected PSSCH resources.

Measurements of signal strength or other signal properties may aid projections for where a control resource or data resource may be used. A reference signal received power (RSRP) measurement of the SCI-1 and SCI-2 may lead to RSRP projections for SCI-1 530 and RSRP projections for SCI-1 535, respectively. In other examples, other types of measurements may be used to determine projections of the data transmission scheduling or of a re-transmission of an SCI message. RSRP projections 540 may also be used to determine where the SCI-1 may point to in the data resource pool.

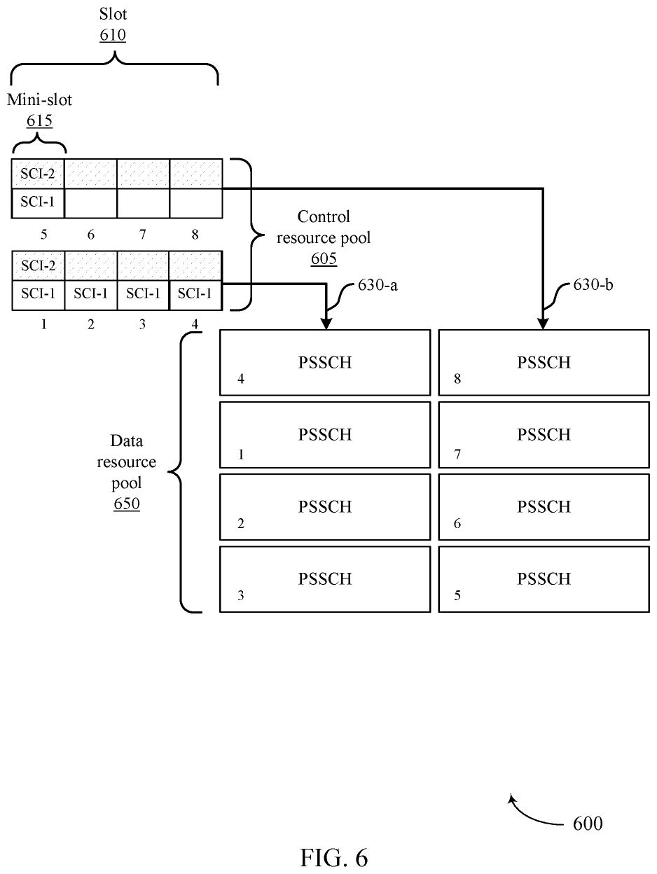

FIG. 6 illustrates an example of a block diagram 600 that supports data scheduling collision avoidance and priority based resource selection with decoupled sidelink control and data in accordance with aspects of the present disclosure. The block diagram 600 shows a control resource pool 605 and a data resource pool 650. The block diagram 600 may illustrate mapping between different control resources from the control resource pool 605 and different data resources from the data resource pool 650. The block diagram 600 may illustrate sidelink support for cross carrier scheduling for 6 GHz and mmW (e.g. 60 GHz). A wireless device, such as a UE, may send control signaling (e.g., SCI) in 6 GHz PSCCH to schedule data transmissions in PSSCH in mmW.

The control resource pool 605 may include a plurality of slots 610 which comprise mini-slots 615, and which are numbered from 1 to 8 for illustrative purposes. The data resource pool 650 may be comprise PSCCH resources, which are likewise numbered from 1 to 8 for illustrative purposes. The control resources of the control resource pool 605 may map to the data resources of the data resource pool 650 having the same number as the control resources. The control resource pool 605 shows two subchannels. The data resource pool 650 may include four subchannels, subchannel 0 through subchannel 3.

Time domain restricted resource selection is illustrated in the example of FIG. 6. Different control subchannels of the control resource pool 605 may map to different data slots in the data resource pool 650 to resolve some of the half duplex problems of the UEs. Control mini-slots may be frequency division multiplexed, and transmitters may schedule PSSCH in the different slots for initial transmission. A UE not receive a future reservation may not pose a scheduling conflict because the UE may have the full scheduling flexibility in FDRA.

A UE may be free to choose any of the PSSCH slots in the data resource pool 650 and any of the subchannels in the control resource pool. However, if there are two transmitters transmitting SCI messages in the same slot or mini-slot but in different subchannels, and if the SCI messages are reserving or scheduling anything for the future, they may collide with each other. Because the transmitters may not receive while they are transmitting (e.g., due to half-duplex), the transmitters may not know that their data transmissions may collide in the data resources because they cannot hear each other's transmission.

In this example, a mapping between the resources may be defined. For example, if a first UE is transmitting an SCI message in the control subchannel 0, then it can only choose the slot i for the data transmission. However, it is free to choose any of the different subchannels within this slot I, represented by slot 630-a. If a second UE selects subchannel 2 for an SCI message, then it is mapped to slot i+1, represented by slot 630-b. This ensures that if two UEs are transmitting SCI messages in the same slot or mini-slot, although they cannot hear each other, they will not collide with the data resource scheduling according to the resource mapping rule. That is, different slots 610 or mini-slots 615 of the control resource pool 605 map to unique slots for the PDSSH in the data resource pool 650.

For example, if a first UE transmits an SCI message in mini-slot 3 of the control resource pool 605, the SCI message indicates a data resource in the slot 630-a, which may correspond to the PDSSH numbered 3. If a second UE transmits a second SCI message in the same mini-slot 7, then the second SCI message maps to a data resource pool in the slot 630-b, which may correspond to the PDSSH numbered 7. This way, even though the UEs may not hear or detect each other, they can avoid a scheduling conflict in the data resource pool 650.

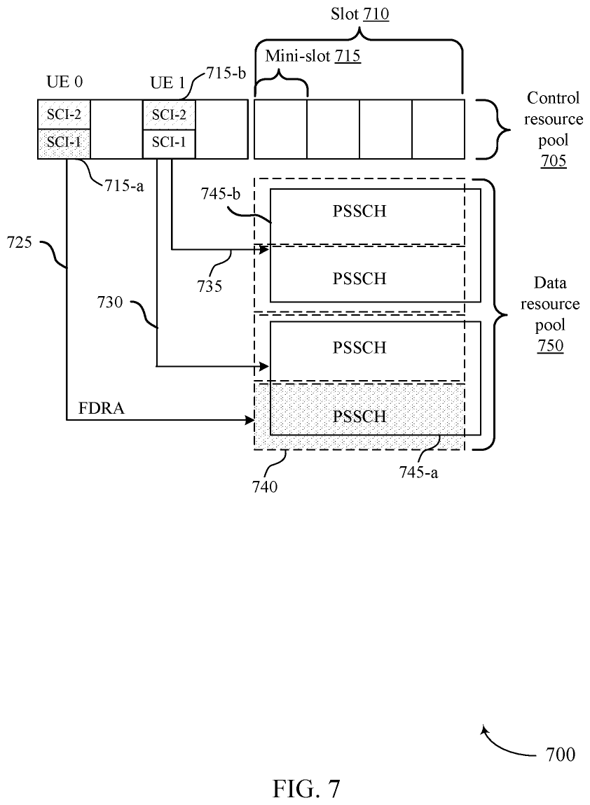

FIG. 7 illustrates an example of a block diagram 700 that supports data scheduling collision avoidance and priority based resource selection with decoupled sidelink control and data in accordance with aspects of the present disclosure. The block diagram 700 shows a control resource pool 705 and a data resource pool 750. The block diagram 700 may illustrate mapping between different control resources from the control resource pool 705 and different data resources from the data resource pool 750. The block diagram 700 may illustrate sidelink support for cross carrier scheduling for 6 GHz and mmW (e.g. 60 GHz). A wireless device, such as a UE, may send control signaling (e.g., SCI) in 6 GHz PSCCH to schedule data transmissions in PSSCH in mmW.

The control resource pool 705 may include a plurality of slots 710 which comprise mini-slots 715. The data resource pool 750 may be comprise PSCCH resources. The control resource pool 705 shows a single subchannel. With the mini-slot control resource pool 705, a second UE, such as UE 1, may hear a FDRA or TDRA transmission from a first UE, such as UE 0, transmitting in an earlier mini-slot 715-a. Based on the UE 1 detecting the FDRA or TDRA transmission, it may avoid scheduling PSSCH in a conflicting data resource. Techniques described herein provide mechanisms or structure in the mini-slot control resource pool 705 to enable PSSCH scheduling collision avoidance.

In some examples, the resource selection procedure may be modified from a random selection to exploit the fact that an earlier control mini-slot (such as mini-slot 715-a) may have a higher scheduling priority than a later control mini-slot (such as mini-slot 715-b). That is, the selection of resources may be based upon traffic priority.

In some examples, the UE intending to transmit an SCI message (e.g., UE 1) may monitor the mini-slot 715-a for SCI messages from other UEs in the same control subchannel (e.g., UE 0). If the UE 1 detects a potential scheduling conflict, it may re-adjust the FDRA or perform resource re-selection.

In this example, if UE 0 transmits in the first mini-slot 715-a and UE 1 transmits in the third mini-slot 715-b, then UE 1 can detect that the FDRA scheduled by UE 1 will collide with the scheduled FDRA of UE 0. This is illustrated in FIG. 7 by mapping 725, which shows how the first mini-slot 715-a maps to the PSSCH resource 740. UE 1 may have to readjust its FDRA in the SCI-1 to be transmitted in the third mini-slot 715-b in order to avoid the collision. Some techniques allow processing time for UE 1 to modify the FDRA or perform a resource reselection in order to transmit an updated SCI-1 with a rescheduled data resource so as to not collide with the data resource scheduled by UE 0. Mappings 730 and 735 may point to additional data resources in the PSSCH.

For example, UE 0 may indicate in an SCI message that two slots later it will transmit in the PSSCH resource 740. UE 1 may sense the SCI message, decode it, and determine that the intended data resource for a data transmission has at least a partial overlap with the PSSCH resource 740. Although UE 1 had already made the decision to also use the PSSCH resource 740, for example, before UE 1 transmits its SCI message, it performs sensing and decoding for SCI messages. UE 1 may tweak its data resource at the last moment to avoid a scheduling conflict. In other words, UE 1 may change its data resource at the last minute if it detects a possible collision in PSSCH based on what it detects in the PSCCH. These techniques may apply to initial transmissions of SCI messages. In some examples, retransmissions of SCI in the same slot may not result in this type of scheduling conflict.

Techniques described herein function as a time-restricted mapping, where different control subchannel maps to different slots and a UE may only choose from among the available subchannel within the particular slot. Even if the UEs choose different control mini-slots in the same control subchannel, there may be a chance that the scheduled PSSCHs may collide with each other as the UEs in different control mini-slots 715 may freely choose their own FDRA. For example, UE 0 may schedule a data transmission in PSSCH resource 740 and UE 1 may have planned to schedule a data transmission in PSSCH 745-a, which may conflict with the PSSCH resource 740 because they have some overlap.

UE 1, which occupies the later control mini-slot 715-b, may know the FDRA of the earlier UE 0 and could possibly choose a non-conflicting subchannel. In one example, UE 1 intending to transmit an SCI message will monitor the mini-slot SCI-1 from other UEs in the same control subchannel and re-adjust the FDRA or perform resource re-selection for the SCI transmission if a possible future collision in the data RP is detected. UE 1 may monitor the other UEs SCI-1 messages in the same control subchannel (e.g., the same control resource pool 705) and earlier mini-slots in the same slot. In some examples, the scheduling decision may be made ahead of time of the transmission of the SCI message (e.g., 2 ms before transmission of the SCI message). UE 1 may perform real-time checking after the scheduling decision is made at the MAC layer of UE 1.

Several alternatives are described if the conflicting FDRA is determined by the SCI-1 message. If the processing time allows, UE 1 may choose a different data resource. Alternatively, UE 1 may prepare multiple copies of SCI waveforms with different FDRA and, if a scheduling conflict is detected, UE 1 may choose an FDRA that is not conflicting. That is, when the MAC layer of UE 1 makes the scheduling decision, it may come up with different options for the subchannel selection, and then choose a preferable one that does not conflict. However, if a collision is later detected by UE 1 in the physical layer, it can switch to a different option of the MAC layer's decision.

Alternatively, if processing time is permitted, UE 1 can re-generate the SCI waveform with a non-conflicting FDRA. If the conflicting FDRA is detected right before the SCI transmission and UE 1 cannot accommodate modifying FDRA in its timeline, UE 1 may run joint resource re-selection. Both options may be implemented depending on when the conflicting FDRA is detected and the processing timeline of UE 1.

For example, if UE 1 is a low capability sidelink node, it may require 3 mini-slots to generate a new waveform of SCI with different FDRA. If UE 1 does not have the capability to do the real-time generation/multiplication of SCI-1 when it detects a collision and also schedule over conflicting subchannels, then it can run joint resource re-selection. That is, UE 1 may give up the transmission of the SCI-1 in PSSCH 745-a, and then retransmit the SCI-1 in the future slot for the SCI-1. UE 1 may try to reschedule a new FDRA for the data transmission, such as PSSCH 745-b.

In some examples, UE 1 may transmit the original SCI-1, but state in the SCI-1 field that it is reserving future resources for the SCI transmission but isn't going to transmit in PSSCH 745-a. This basically suspends the data transmission in PSSCH 745-a. That is, the SCI may be used to reserve future resources for future re-transmissions of SCI with different FDRA.

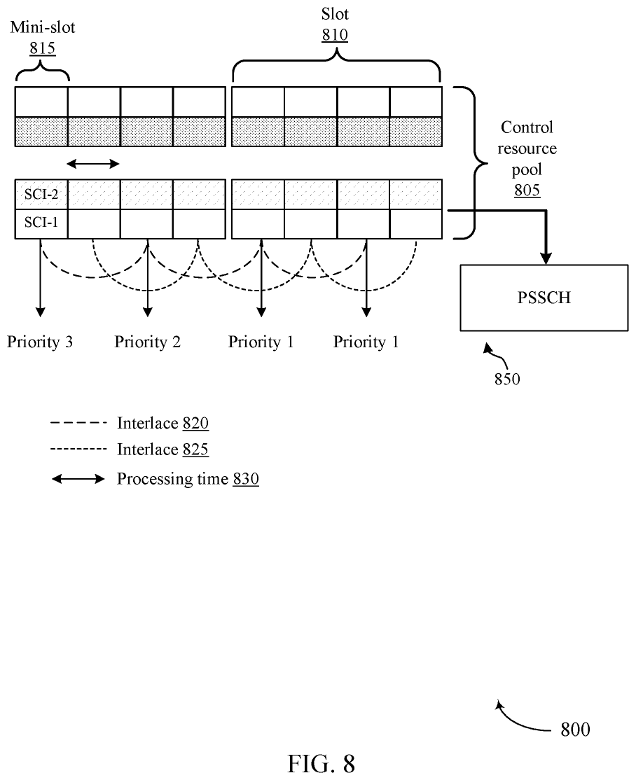

FIG. 8 illustrates an example of a block diagram 800 that supports data scheduling collision avoidance and priority based resource selection with decoupled sidelink control and data in accordance with aspects of the present disclosure. The block diagram 800 shows a control resource pool 805 and a data resource pool 850. The block diagram 800 may illustrate mapping between different control resources from the control resource pool 805 and different data resources from the data resource pool 850. The block diagram 800 may illustrate sidelink support for cross carrier scheduling for 6 GHz and mmW (e.g. 60 GHz). A wireless device, such as a UE, may send control signaling (e.g., SCI) in 6 GHz PSCCH to schedule data transmissions in PSSCH in mmW. FIG. 8 illustrates an example time interlace for the mini-slots 815.

The control resource pool 805 may include a plurality of slots 810 which comprise mini-slots 815. The data resource pool 850 may be comprise PSCCH resources. The control resource pool 805 shows two subchannels. In some examples, priority based resource selection in the control resource pool 705 may be used. The mini-slots 815 may be partitioned into time interlaces, such as interlace 820 and interlace 825. The interlaces 820 and 825 may map to different slots in the data resource pool 850. Likewise, different control subchannels may map to different slots in the data resource pool 850. A UE having higher priority traffic may choose either control mini-slot within a given interlace.

Two levels for resource selection may be provided. In the first level, the UE may randomly select a resource among groups of contiguous slots (e.g., interlaces 820 and 825). The second level may allow for resource selection within the interlaces 820 and 825 based on traffic priority. These levels may be applied to either the data resource pool 850 or the control resource pool 805. The earlier control mini-slot in an interlace may have higher priority than later mini-slots within the interlace.

Additionally, priority based resource selection may be used for the control resource pool 805. Within one interlace, the starting UE is free to choose among all the available subchannels within the PSSCH slot. Within this structure, the UE with the higher traffic priority in the resource selection within the control resource pool 805 can choose the earlier mini-slot within one interlace. For example, within interlace 820, the first mini-slot is always reserved for priority 3 traffic. This enables the lower priority UE to hear the higher priority transmitted SCI and can perform the collision avoidance of the data resource pool 850 according to the priority based resource selection in the control resource pool 805.

In some examples, the mini-slots 815 of the control resource pool 805 are divided into X contiguous slots into Y time domain interlaces, where X and Y are positive whole numbers. Each time interlace may map to a slot in the PSSCH.

In another example, an interlace j may map to a slot i+j. Still different control subchannels map to different slot after interlaces. With interlace mapping, a UE has Y mini-slots to detect the conflicting FDRA and to modify the FDRA in the same slot.

The interlace design may take into account the duration of the UE processing time 840. For example, if the SCI-1 is transmitted, then the UE may need some processing time 840 to detect the SCI-1, decode it, and process it before it can do any transmission avoidance. Because different time interlaces are mapped to different slots, the SCI transmitted in the adjacent mini-slots will not collide in the data resource. However, within the same interlace, they might collide. In some examples, a one slot gap may be between the control resources within one interlace, which may allow one mini-slot of processing time 840. For example, if a first UE transmits on a first mini-slot of interlace 820, the next UE, which detects interlace 820, can only transmit in the second mini-slot in interlace 820. Between the transmission of SCI-1 of both UEs, there is one mini-slot. The second UE may sense the SCI-1 of the first UE, use the time of the mini-slot gap to decode the SCI-1, and determine if the data resource scheduled by the SCI-1 is conflicting in the data resources.

The interlace approaches may be used when the conflicting FDRA is scheduled in a previous mini-slot right before a chosen control mini-slot for an SCI transmission, such that the UE may not be able detect the FDRA conflict and adjust the FDRA in time. Using the interlace method enables the UE to avoid having to make FDRA modifications, which may take some time for the UE.

Priority based resource selection in the control resource pool may also be used. In some examples, the UE taking the earlier control mini-slot will have a high priority in nature as the later UE will avoid choosing a conflicting FDRA. With random resource selection in the control resource pool 805, every UE has equal probability being the high priority UE on average. In some examples, the control resource selection may be prioritized based on traffic.

Examples described herein may include a two stage resource reselection for the control resource pool 805. For example, the UE with the higher priority traffic may choose an earlier mini-slot within the control resource pool 805 within an interlace, such as interlace 820. In some examples, a matching resource selection algorithm may be used. In some examples, the UE with the higher priority traffic may choose the earlier control mini-slot within an interlace.

Within the control resource pool 805, the resource selection may include a first stage random selection. The random selection may be purely random. Random selection may be performed among different X-slot segments (e.g., each X-slot contains Y time domain interlaces). In some examples, a UE may randomly choose among Y interlaces within the chosen X-slot segment.

The resource selection may also include a second stage priority-based resource selection. The UE may choose the mini-slot within the chosen interlace based on the traffic priority. That is, after the first random selection, the UE may randomly choose the control sub-channel in the frequency domain. Higher priority may map to earlier mini-slots in an interlace. An interlace index and a control subchannel index may have a 1 to 1 mapping to a slot index in the data resource pool 850. With these two indexes, the UE can only pick a certain slot within the data resource pool 850. In the second stage of the resource selection, there may be a priority based resource selection, which may include choosing the mini-slot based upon the traffic priority.

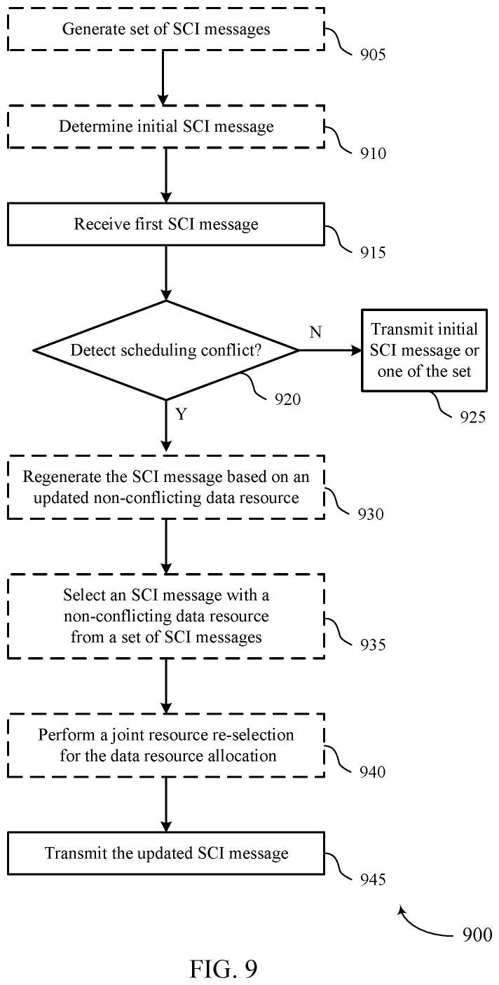

FIG. 9 illustrates an example of a flowchart 900 that supports data scheduling collision avoidance and priority based resource selection with decoupled sidelink control and data in accordance with aspects of the present disclosure. The operations of the flowchart 900 may be implemented by a UE or its components as described herein. For example, the operations of the flowchart 900 may be performed by a UE 115 as described with reference to FIGS. 1-3 and 10-13. In some examples, a UE may execute a set of instructions to control the functional elements of the UE to perform the described functions. Additionally, or alternatively, the UE may perform aspects of the described functions using special-purpose hardware.

At 905, the UE may optionally generate a set of SCI messages with different data resources (e.g., FDRA). Alternatively, the UE may determine an initial SCI message with a data resource at 910.

At 915, the UE may receive a first SCI message from another UE. At 920, the UE may determine if it detects a scheduling conflict from decoding the first SCI message. If not, at 925, the UE may transmit the initial SCI message or a selected SCI message from the set of SCI messages that does not conflict with the first SCI message.

If there is a scheduling conflict detected, the UE may perform one of three alternative options for mitigating the scheduling conflict. At 930, the UE may regenerate the initial SCI message based on an updated non-conflicting data resource. Alternatively, at 935, if the UE generated the set of SCI messages, the UE may select an SCI message with a non-conflicting data resource from the set of SCI messages. Alternatively, at 940, the UE may perform a joint resource re-selection for the data resource allocation.

Regardless of how the UE determines a non-conflicting data resource to include in the SCI message, the UE may transmit the updated SCI message with the non-conflicting data resource identification at 945.

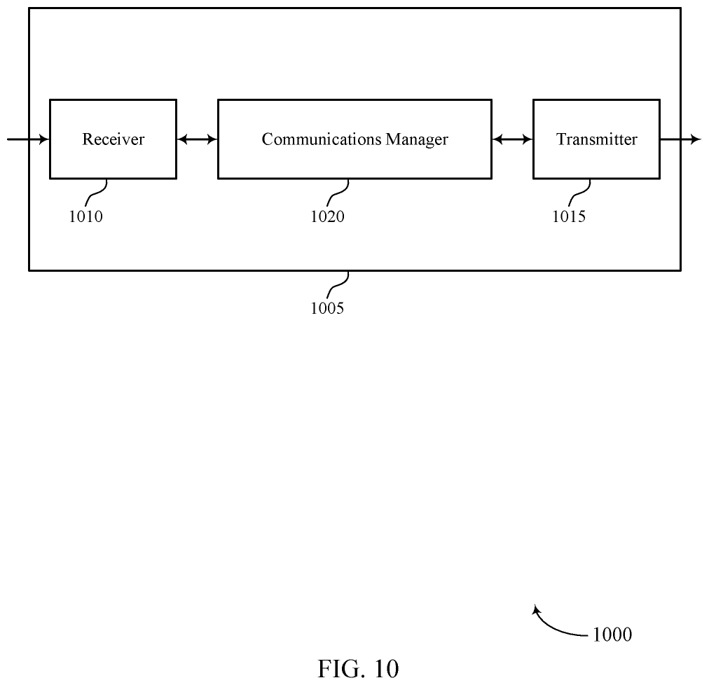

FIG. 10 shows a block diagram 1000 of a device 1005 that supports data scheduling collision avoidance and priority based resource selection with decoupled sidelink control and data in accordance with aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to data scheduling collision avoidance and priority based resource selection with decoupled sidelink control and data). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to data scheduling collision avoidance and priority based resource selection with decoupled sidelink control and data). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of data scheduling collision avoidance and priority based resource selection with decoupled sidelink control and data as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device (PLD), a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first wireless device in accordance with examples as disclosed herein. For example, the communications manager 1020 may be configured as or otherwise support a means for receiving, at the first wireless device, a first SCI message from a second wireless device, where the first SCI message indicates a scheduling conflict between a first data transmission of the second wireless device and a second data transmission of the first wireless device. The communications manager 1020 may be configured as or otherwise support a means for transmitting a second SCI message from the first wireless device based on the scheduling conflict between the first data transmission and the second data transmission, where the second SCI message indicates a data resource allocation for the second data transmission that mitigates the scheduling conflict.

Additionally, or alternatively, the communications manager 1020 may support wireless communication at a wireless device in accordance with examples as disclosed herein. For example, the communications manager 1020 may be configured as or otherwise support a means for generating a SCI message, where the SCI message is associated with a time domain interlace of a set of multiple control resources and indicates a data resource for a data transmission based on the time domain interlace. The communications manager 1020 may be configured as or otherwise support a means for transmitting the SCI message in a mini-slot of a control resource of the set of multiple control resources associated with the time domain interlace.

Additionally, or alternatively, the communications manager 1020 may support wireless communication at a wireless device in accordance with examples as disclosed herein. For example, the communications manager 1020 may be configured as or otherwise support a means for receiving a SCI message in a mini-slot of a control resource associated with a time domain interlace. The communications manager 1020 may be configured as or otherwise support a means for decoding the SCI message, where the SCI message indicates a data resource for a data transmission based on the time domain interlace.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing due to less retransmissions, reduced power consumption, and more efficient utilization of communication resources.

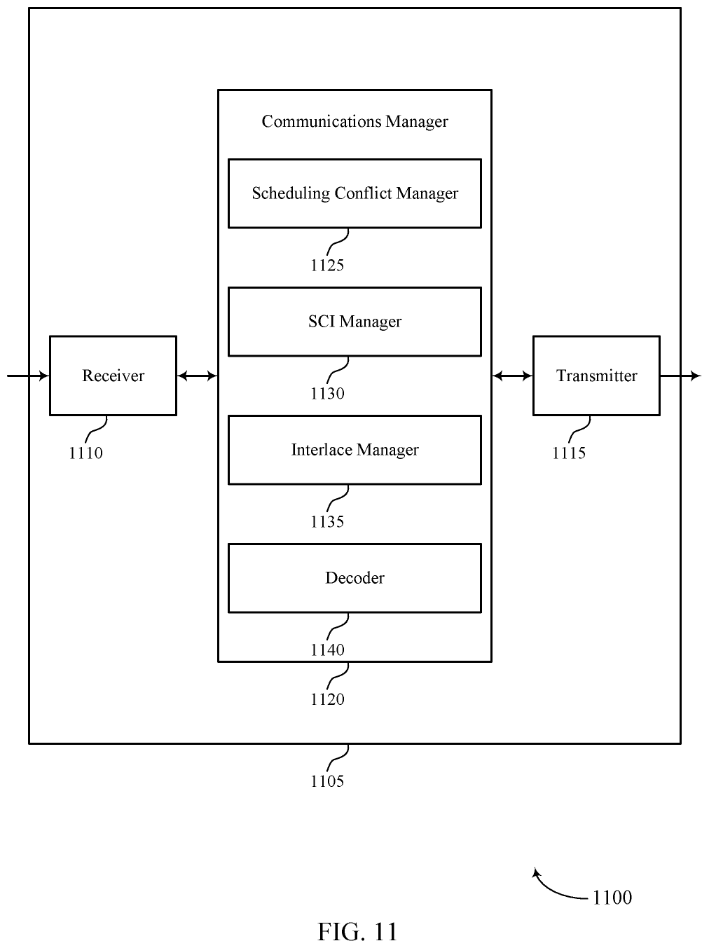

FIG. 11 shows a block diagram 1100 of a device 1105 that supports data scheduling collision avoidance and priority based resource selection with decoupled sidelink control and data in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to data scheduling collision avoidance and priority based resource selection with decoupled sidelink control and data). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to data scheduling collision avoidance and priority based resource selection with decoupled sidelink control and data). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of data scheduling collision avoidance and priority based resource selection with decoupled sidelink control and data as described herein. For example, the communications manager 1120 may include a scheduling conflict manager 1125, an SCI manager 1130, an interlace manager 1135, a decoder 1140, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first wireless device in accordance with examples as disclosed herein. The scheduling conflict manager 1125 may be configured as or otherwise support a means for receiving, at the first wireless device, a first SCI message from a second wireless device, where the first SCI message indicates a scheduling conflict between a first data transmission of the second wireless device and a second data transmission of the first wireless device. The SCI manager 1130 may be configured as or otherwise support a means for transmitting a second SCI message from the first wireless device based on the scheduling conflict between the first data transmission and the second data transmission, where the second SCI message indicates a data resource allocation for the second data transmission that mitigates the scheduling conflict.

Additionally, or alternatively, the communications manager 1120 may support wireless communication at a wireless device in accordance with examples as disclosed herein. The interlace manager 1135 may be configured as or otherwise support a means for generating a SCI message, where the SCI message is associated with a time domain interlace of a set of multiple control resources and indicates a data resource for a data transmission based on the time domain interlace. The SCI manager 1130 may be configured as or otherwise support a means for transmitting the SCI message in a mini-slot of a control resource of the set of multiple control resources associated with the time domain interlace.

Additionally, or alternatively, the communications manager 1120 may support wireless communication at a wireless device in accordance with examples as disclosed herein. The interlace manager 1135 may be configured as or otherwise support a means for receiving a SCI message in a mini-slot of a control resource associated with a time domain interlace. The decoder 1140 may be configured as or otherwise support a means for decoding the SCI message, where the SCI message indicates a data resource for a data transmission based on the time domain interlace.

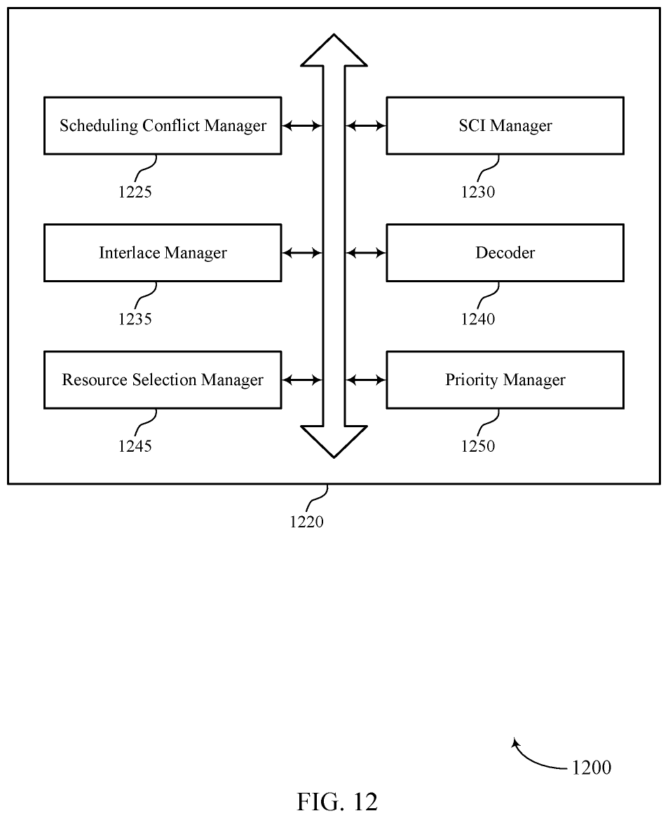

FIG. 12 shows a block diagram 1200 of a communications manager 1220 that supports data scheduling collision avoidance and priority based resource selection with decoupled sidelink control and data in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of data scheduling collision avoidance and priority based resource selection with decoupled sidelink control and data as described herein. For example, the communications manager 1220 may include a scheduling conflict manager 1225, an SCI manager 1230, an interlace manager 1235, a decoder 1240, a resource selection manager 1245, a priority manager 1250, or any combination thereof. Each of these components may communicate, directly or indirectly, with one another (e.g., via one or more buses).

The communications manager 1220 may support wireless communication at a first wireless device in accordance with examples as disclosed herein. The scheduling conflict manager 1225 may be configured as or otherwise support a means for receiving, at the first wireless device, a first SCI message from a second wireless device, where the first SCI message indicates a scheduling conflict between a first data transmission of the second wireless device and a second data transmission of the first wireless device. The SCI manager 1230 may be configured as or otherwise support a means for transmitting a second SCI message from the first wireless device based on the scheduling conflict between the first data transmission and the second data transmission, where the second SCI message indicates a data resource allocation for the second data transmission that mitigates the scheduling conflict.

In some examples, to support first SCI message indicates the scheduling conflict, the decoder 1240 may be configured as or otherwise support a means for decoding the first SCI message, where the decoded first SCI message indicates a first data resource for the first data transmission. In some examples, to support first SCI message indicates the scheduling conflict, the scheduling conflict manager 1225 may be configured as or otherwise support a means for comparing the first data resource for the first data transmission with a second data resource for the second data transmission. In some examples, to support first SCI message indicates the scheduling conflict, the scheduling conflict manager 1225 may be configured as or otherwise support a means for determining that there is at least a partial overlap between the first data resource for the first data transmission and the second data resource for the second data transmission.

In some examples, the scheduling conflict manager 1225 may be configured as or otherwise support a means for determining a time period between receiving the first SCI message and a transmission time for the second SCI message.

In some examples, the scheduling conflict manager 1225 may be configured as or otherwise support a means for determining that the time period is greater than a generation time for generating the second SCI message based on a comparison of the time period with a processing time for generating the second SCI message. In some examples, the SCI manager 1230 may be configured as or otherwise support a means for selecting a third data resource for the second data transmission based on the indication of the scheduling conflict in the second SCI message such that the third data resource for the second data transmission is non-conflicting with a first data resource for the first data transmission. In some examples, the SCI manager 1230 may be configured as or otherwise support a means for generating the second SCI message for the second data transmission based on the third data resource, where the third data resource includes the data resource allocation.

In some examples, the scheduling conflict manager 1225 may be configured as or otherwise support a means for determining that the time period is greater than a modification time for modifying the second SCI message based on a comparison of the time period with a processing time for modifying the second SCI message. In some examples, the SCI manager 1230 may be configured as or otherwise support a means for selecting a third data resource for the second data transmission based on the indication of the scheduling conflict in the second SCI message such that the third data resource for the second data transmission is non-conflicting with a first data resource for the first data transmission. In some examples, the SCI manager 1230 may be configured as or otherwise support a means for modifying the second SCI message for the second data transmission based on the third data resource, where the third data resource includes the data resource allocation.

In some examples, the scheduling conflict manager 1225 may be configured as or otherwise support a means for comparing the time period with a processing time threshold. In some examples, the scheduling conflict manager 1225 may be configured as or otherwise support a means for determining that the time period is less than the processing time threshold. In some examples, the SCI manager 1230 may be configured as or otherwise support a means for selecting the second SCI message from a set of SCI messages based on the second SCI message indicating the data resource allocation.

In some examples, the scheduling conflict manager 1225 may be configured as or otherwise support a means for comparing the time period with a processing time threshold. In some examples, the scheduling conflict manager 1225 may be configured as or otherwise support a means for determining that the time period is less than the processing time threshold. In some examples, the resource selection manager 1245 may be configured as or otherwise support a means for performing a joint resource re-selection for the data resource allocation for the second data transmission.

In some examples, the SCI manager 1230 may be configured as or otherwise support a means for generating a set of SCI messages with different data resources. In some examples, the SCI manager 1230 may be configured as or otherwise support a means for selecting the second SCI message from the set of SCI messages based on the second SCI message indicating the data resource allocation.

In some examples, the second SCI message is transmitted in a first radio frequency spectrum band and the second data transmission is transmitted in a second radio frequency spectrum band. In some examples, the second radio frequency spectrum band is different from the first radio frequency spectrum band.

In some examples, the second wireless device has higher priority traffic than the first wireless device.

Additionally, or alternatively, the communications manager 1220 may support wireless communication at a wireless device in accordance with examples as disclosed herein. The interlace manager 1235 may be configured as or otherwise support a means for generating a SCI message, where the SCI message is associated with a time domain interlace of a set of multiple control resources and indicates a data resource for a data transmission based on the time domain interlace. In some examples, the SCI manager 1230 may be configured as or otherwise support a means for transmitting the SCI message in a mini-slot of a control resource of the set of multiple control resources associated with the time domain interlace.

In some examples, the interlace manager 1235 may be configured as or otherwise support a means for selecting the data resource from a slot in a data resource pool, where the slot is based on the time domain interlace.

In some examples, the interlace manager 1235 may be configured as or otherwise support a means for selecting a slot segment from a set of multiple slot segments of a control resource pool. In some examples, the interlace manager 1235 may be configured as or otherwise support a means for selecting the time domain interlace based on the selected slot segment, where the selected slot segment includes the mini-slot.

In some examples, the priority manager 1250 may be configured as or otherwise support a means for selecting the mini-slot associated with the time domain interlace based on a priority of traffic. In some examples, the time domain interlace is associated with a set of mini-slots in the set of multiple control resources in a control subchannel.

Additionally, or alternatively, the communications manager 1220 may support wireless communication at a wireless device in accordance with examples as disclosed herein. In some examples, the interlace manager 1235 may be configured as or otherwise support a means for receiving a SCI message in a mini-slot of a control resource associated with a time domain interlace. The decoder 1240 may be configured as or otherwise support a means for decoding the SCI message, where the SCI message indicates a data resource for a data transmission based on the time domain interlace.

In some examples, the SCI manager 1230 may be configured as or otherwise support a means for receiving the data transmission in the data resource indicated by the SCI message.

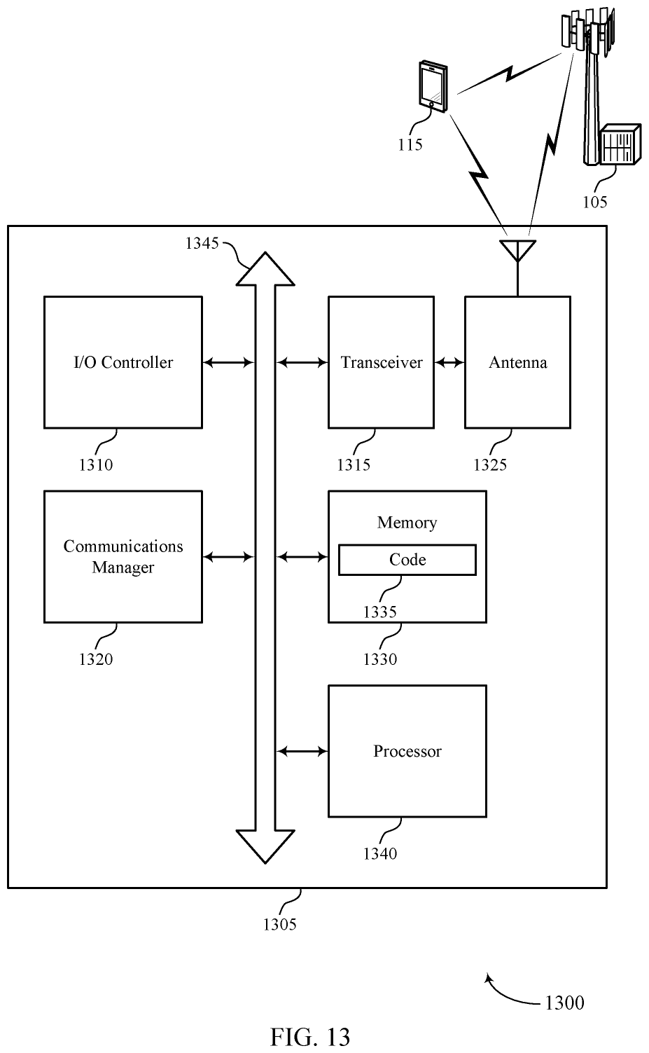

FIG. 13 shows a diagram of a system 1300 including a device 1305 that supports data scheduling collision avoidance and priority based resource selection with decoupled sidelink control and data in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a PLD, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting data scheduling collision avoidance and priority based resource selection with decoupled sidelink control and data). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a first wireless device in accordance with examples as disclosed herein. For example, the communications manager 1320 may be configured as or otherwise support a means for receiving, at the first wireless device, a first SCI message from a second wireless device, where the first SCI message indicates a scheduling conflict between a first data transmission of the second wireless device and a second data transmission of the first wireless device. The communications manager 1320 may be configured as or otherwise support a means for transmitting a second SCI message from the first wireless device based on the scheduling conflict between the first data transmission and the second data transmission, where the second SCI message indicates a data resource allocation for the second data transmission that mitigates the scheduling conflict.

Additionally, or alternatively, the communications manager 1320 may support wireless communication at a wireless device in accordance with examples as disclosed herein. For example, the communications manager 1320 may be configured as or otherwise support a means for generating a SCI message, where the SCI message is associated with a time domain interlace of a set of multiple control resources and indicates a data resource for a data transmission based on the time domain interlace. The communications manager 1320 may be configured as or otherwise support a means for transmitting the SCI message in a mini-slot of a control resource of the set of multiple control resources associated with the time domain interlace.

Additionally, or alternatively, the communications manager 1320 may support wireless communication at a wireless device in accordance with examples as disclosed herein. For example, the communications manager 1320 may be configured as or otherwise support a means for receiving a SCI message in a mini-slot of a control resource associated with a time domain interlace. The communications manager 1320 may be configured as or otherwise support a means for decoding the SCI message, where the SCI message indicates a data resource for a data transmission based on the time domain interlace.

By including or configuring the communications manager 1320 in accordance with examples as described herein, the device 1305 may support techniques for improved communication reliability, reduced latency, improved user experience related to reduced processing and interference, reduced power consumption, more efficient utilization of communication resources, improved coordination between devices, and longer battery life.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of data scheduling collision avoidance and priority based resource selection with decoupled sidelink control and data as described herein, or the processor 1340 and the memory 1330 may be otherwise configured to perform or support such operations.

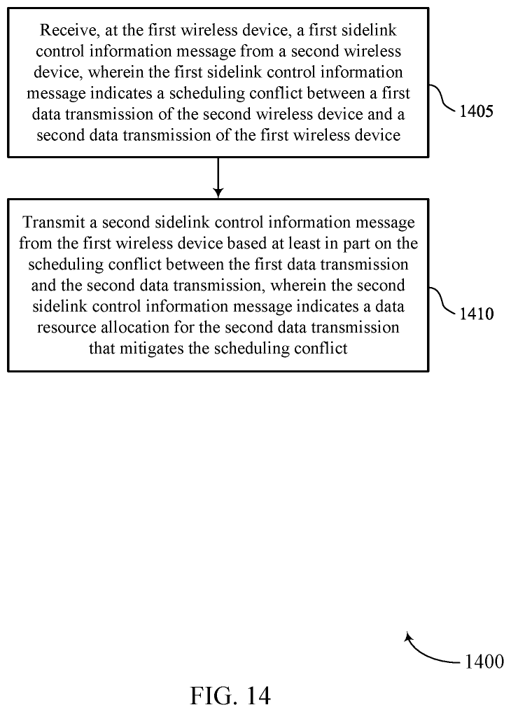

FIG. 14 shows a flowchart illustrating a method 1400 that supports data scheduling collision avoidance and priority based resource selection with decoupled sidelink control and data in accordance with aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include receiving, at the first wireless device, a first SCI message from a second wireless device, where the first SCI message indicates a scheduling conflict between a first data transmission of the second wireless device and a second data transmission of the first wireless device. The operations of 1405 may be performed in accordance with examples as disclosed herein. In some examples, aspects of the operations of 1405 may be performed by a scheduling conflict manager 1225 as described with reference to FIG. 12.

At 1410, the method may include transmitting a second SCI message from the first wireless device based on the scheduling conflict between the first data transmission and the second data transmission, where the second SCI message indicates a data resource allocation for the second data transmission that mitigates the scheduling conflict. The operations of 1410 may be performed in accordance with examples as disclosed herein. In some examples, aspects of the operations of 1410 may be performed by an SCI manager 1230 as described with reference to FIG. 12.

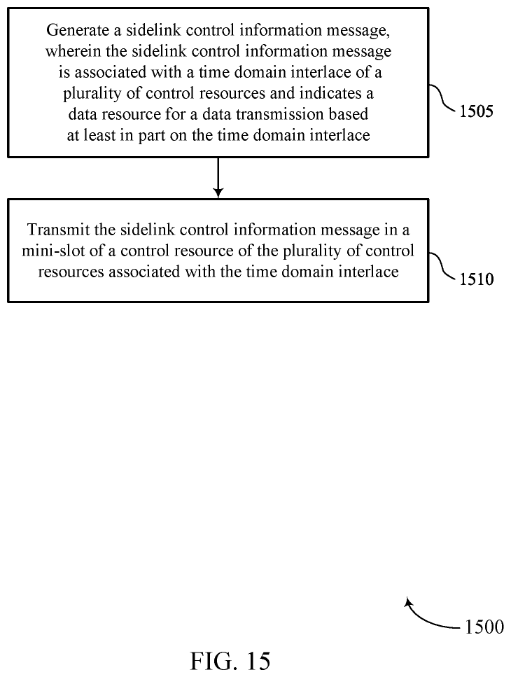

FIG. 15 shows a flowchart illustrating a method 1500 that supports data scheduling collision avoidance and priority based resource selection with decoupled sidelink control and data in accordance with aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include generating a SCI message, where the SCI message is associated with a time domain interlace of a set of multiple control resources and indicates a data resource for a data transmission based on the time domain interlace. The operations of 1505 may be performed in accordance with examples as disclosed herein. In some examples, aspects of the operations of 1505 may be performed by an interlace manager 1235 as described with reference to FIG. 12.

At 1510, the method may include transmitting the SCI message in a mini-slot of a control resource of the set of multiple control resources associated with the time domain interlace. The operations of 1510 may be performed in accordance with examples as disclosed herein. In some examples, aspects of the operations of 1510 may be performed by an SCI manager 1230 as described with reference to FIG. 12.

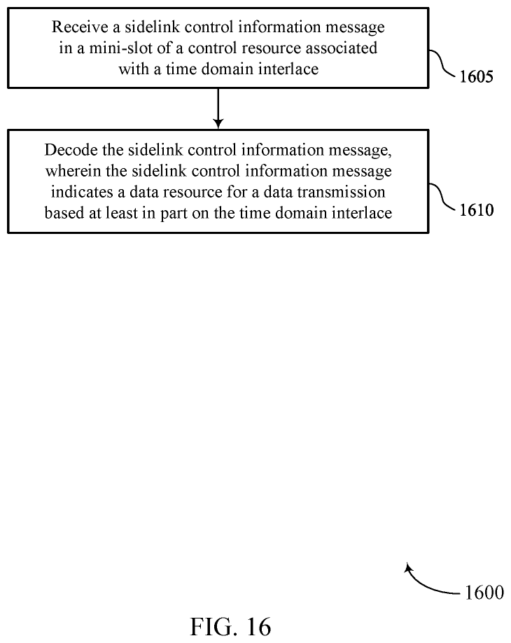

FIG. 16 shows a flowchart illustrating a method 1600 that supports data scheduling collision avoidance and priority based resource selection with decoupled sidelink control and data in accordance with aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1605, the method may include receiving a SCI message in a mini-slot of a control resource associated with a time domain interlace. The operations of 1605 may be performed in accordance with examples as disclosed herein. In some examples, aspects of the operations of 1605 may be performed by an interlace manager 1235 as described with reference to FIG. 12.

At 1610, the method may include decoding the SCI message, where the SCI message indicates a data resource for a data transmission based on the time domain interlace. The operations of 1610 may be performed in accordance with examples as disclosed herein. In some examples, aspects of the operations of 1610 may be performed by a decoder 1240 as described with reference to FIG. 12.

The following provides an overview of aspects of the present disclosure:

Aspect 1: A method for wireless communication at a first wireless device, comprising: receiving, at the first wireless device, a first sidelink control information message from a second wireless device, wherein the first sidelink control information message indicates a scheduling conflict between a first data transmission of the second wireless device and a second data transmission of the first wireless device; and transmitting a second sidelink control information message from the first wireless device based at least in part on the scheduling conflict between the first data transmission and the second data transmission, wherein the second sidelink control information message indicates a data resource allocation for the second data transmission that mitigates the scheduling conflict.

Aspect 2: The method of aspect 1, wherein the first sidelink control information message indicates the scheduling conflict further comprises: decoding the first sidelink control information message, wherein the decoded first sidelink control information message indicates a first data resource for the first data transmission; comparing the first data resource for the first data transmission with a second data resource for the second data transmission; and determining that there is at least a partial overlap between the first data resource for the first data transmission and the second data resource for the second data transmission.

Aspect 3: The method of any of aspects 1 through 2, further comprising: determining a time period between receiving the first sidelink control information message and a transmission time for the second sidelink control information message.

Aspect 4: The method of aspect 3, further comprising: determining that the time period is greater than a generation time for generating the second sidelink control information message based at least in part on a comparison of the time period with a processing time for generating the second sidelink control information message; selecting a third data resource for the second data transmission based on the second SCI message such that the third data resource for the second data transmission is non-conflicting with a first data resource for the first data transmission; generating the second sidelink control information message for the second data transmission based at least in part on the third data resource, wherein the third data resource comprises the data resource allocation.

Aspect 5: The method of any of aspects 3 through 4, further comprising: determining that the time period is greater than a modification time for modifying the second sidelink control information message based at least in part on a comparison of the time period with a processing time for modifying the second sidelink control information message; selecting a third data resource for the second data transmission based on the second SCI message such that the third data resource for the second data transmission is non-conflicting with a first data resource for the first data transmission; modifying the second sidelink control information message for the second data transmission based at least in part on the third data resource, wherein the third data resource comprises the data resource allocation.

Aspect 6: The method of any of aspects 3 through 5, further comprising: comparing the time period with a processing time threshold; determining that the time period is less than the processing time threshold; and selecting the second sidelink control information message from a set of sidelink control information messages based at least in part on the second sidelink control information message indicating the data resource allocation.

Aspect 7: The method of any of aspects 3 through 6, further comprising: comparing the time period with a processing time threshold; determining that the time period is less than the processing time threshold; and performing a joint resource re-selection for the data resource allocation for the second data transmission.

Aspect 8: The method of any of aspects 1 through 7, further comprising: generating a set of sidelink control information messages with different data resources; selecting the second sidelink control information message from the set of sidelink control information messages based at least in part on the second sidelink control information message indicating the data resource allocation.

Aspect 9: The method of any of aspects 1 through 8, wherein the second sidelink control information message is transmitted in a first radio frequency spectrum band and the second data transmission is transmitted in a second radio frequency spectrum band, the second radio frequency spectrum band is different from the first radio frequency spectrum band.

Aspect 10: The method of any of aspects 1 through 9, wherein the second wireless device has higher priority traffic than the first wireless device.

Aspect 11: A method for wireless communication at a wireless device, comprising: generating a sidelink control information message, wherein the sidelink control information message is associated with a time domain interlace of a plurality of control resources and indicates a data resource for a data transmission based at least in part on the time domain interlace; and transmitting the sidelink control information message in a mini-slot of a control resource of the plurality of control resources associated with the time domain interlace.

Aspect 12: The method of aspect 11, further comprising: selecting the data resource from a slot in a data resource pool, wherein the slot is based at least in part on the time domain interlace.

Aspect 13: The method of any of aspects 11 through 12, further comprising: selecting a slot segment from a plurality of slot segments of a control resource pool; and selecting the time domain interlace based at least in part on the selected slot segment, wherein the selected slot segment includes the mini-slot.

Aspect 14: The method of aspect 13, further comprising: selecting the mini-slot associated with the time domain interlace based at least in part on a priority of traffic.

Aspect 15: The method of any of aspects 11 through 14, wherein the time domain interlace is associated with a set of mini-slots in the plurality of control resources in a control subchannel.

Aspect 16: A method for wireless communication at a wireless device, comprising: receiving a sidelink control information message in a mini-slot of a control resource associated with a time domain interlace; and decoding the sidelink control information message, wherein the sidelink control information message indicates a data resource for a data transmission based at least in part on the time domain interlace.

Aspect 17: The method of aspect 16, further comprising: receiving the data transmission in the data resource indicated by the sidelink control information message.

Aspect 18: An apparatus for wireless communication at a first wireless device, comprising a processor; memory coupled with the processor; and instructions stored in the memory and executable by the processor to cause the apparatus to perform a method of any of aspects 1 through 10.

Aspect 19: An apparatus for wireless communication at a first wireless device, comprising at least one means for performing a method of any of aspects 1 through 10.

Aspect 20: A non-transitory computer-readable medium storing code for wireless communication at a first wireless device, the code comprising instructions executable by a processor to perform a method of any of aspects 1 through 10.

Aspect 21: An apparatus for wireless communication at a wireless device, comprising a processor; memory coupled with the processor; and instructions stored in the memory and executable by the processor to cause the apparatus to perform a method of any of aspects 11 through 15.

Aspect 22: An apparatus for wireless communication at a wireless device, comprising at least one means for performing a method of any of aspects 11 through 15.

Aspect 23: A non-transitory computer-readable medium storing code for wireless communication at a wireless device, the code comprising instructions executable by a processor to perform a method of any of aspects 11 through 15.

Aspect 24: An apparatus for wireless communication at a wireless device, comprising a processor; memory coupled with the processor; and instructions stored in the memory and executable by the processor to cause the apparatus to perform a method of any of aspects 16 through 17.

Aspect 25: An apparatus for wireless communication at a wireless device, comprising at least one means for performing a method of any of aspects 16 through 17.

Aspect 26: A non-transitory computer-readable medium storing code for wireless communication at a wireless device, the code comprising instructions executable by a processor to perform a method of any of aspects 16 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first wireless device, comprising:
a processor;
memory coupled with the processor; and
instructions stored in the memory and executable by the processor to cause the apparatus to:
receive, at the first wireless device, a first sidelink control information message from a second wireless device, wherein the first sidelink control information message indicates a scheduling conflict between a first data transmission of the second wireless device and a second data transmission of the first wireless device; and
transmit a second sidelink control information message from the first wireless device based at least in part on the scheduling conflict between the first data transmission and the second data transmission, wherein the second sidelink control information message indicates a data resource allocation for the second data transmission that mitigates the scheduling conflict.

2. The apparatus of claim 1, wherein the instructions are further executable by the processor to cause the apparatus to:
decode the first sidelink control information message, wherein the decoded first sidelink control information message indicates a first data resource for the first data transmission;
compare the first data resource for the first data transmission with a second data resource for the second data transmission; and
determine that there is at least a partial overlap between the first data resource for the first data transmission and the second data resource for the second data transmission.

3. The apparatus of claim 1, wherein the instructions are further executable by the processor to cause the apparatus to:
determine a time period between receiving the first sidelink control information message and a transmission time for the second sidelink control information message.

4. The apparatus of claim 3, wherein the instructions are further executable by the processor to cause the apparatus to:
determine that the time period is greater than a generation time for generating the second sidelink control information message based at least in part on a comparison of the time period with a processing time for generating the second sidelink control information message;
select a third data resource for the second data transmission based on the second sidelink control information message such that the third data resource for the second data transmission is non-conflicting with a first data resource for the first data transmission; and
generate the second sidelink control information message for the second data transmission based at least in part on the third data resource, wherein the third data resource comprises the data resource allocation.

5. The apparatus of claim 3, wherein the instructions are further executable by the processor to cause the apparatus to:
determine that the time period is greater than a modification time for modifying the second sidelink control information message based at least in part on a comparison of the time period with a processing time for modifying the second sidelink control information message;
select a third data resource for the second data transmission based on the second sidelink control information message such that the third data resource for the second data transmission is non-conflicting with a first data resource for the first data transmission; and
modify the second sidelink control information message for the second data transmission based at least in part on the third data resource, wherein the third data resource comprises the data resource allocation.

6. The apparatus of claim 3, wherein the instructions are further executable by the processor to cause the apparatus to:
compare the time period with a processing time threshold;
determine that the time period is less than the processing time threshold; and
select the second sidelink control information message from a set of sidelink control information messages based at least in part on the second sidelink control information message indicating the data resource allocation.

7. The apparatus of claim 3, wherein the instructions are further executable by the processor to cause the apparatus to:
compare the time period with a processing time threshold;
determine that the time period is less than the processing time threshold; and
perform a joint resource re-selection for the data resource allocation for the second data transmission.

8. The apparatus of claim 1, wherein the instructions are further executable by the processor to cause the apparatus to:
generate a set of sidelink control information messages with different data resources; and
select the second sidelink control information message from the set of sidelink control information messages based at least in part on the second sidelink control information message indicating the data resource allocation.

9. The apparatus of claim 1, wherein:
the second sidelink control information message is transmitted in a first radio frequency spectrum band and the second data transmission is transmitted in a second radio frequency spectrum band,
the second radio frequency spectrum band is different from the first radio frequency spectrum band.

10. The apparatus of claim 1, wherein the second wireless device has higher priority traffic than the first wireless device.

11. An apparatus for wireless communication at a wireless device, comprising:
a processor;
memory coupled with the processor; and
instructions stored in the memory and executable by the processor to cause the apparatus to:
generate a sidelink control information message, wherein the sidelink control information message is associated with a time domain interlace of a plurality of control resources and indicates a data resource for a data transmission based at least in part on the time domain interlace; and
transmit the sidelink control information message in a mini-slot of a control resource of the plurality of control resources associated with the time domain interlace.

12. The apparatus of claim 11, wherein the instructions are further executable by the processor to cause the apparatus to:
select the data resource from a slot in a data resource pool, wherein the slot is based at least in part on the time domain interlace.

13. The apparatus of claim 11, wherein the instructions are further executable by the processor to cause the apparatus to:
select a slot segment from a plurality of slot segments of a control resource pool; and
select the time domain interlace based at least in part on the selected slot segment, wherein the selected slot segment includes the mini-slot.

14. The apparatus of claim 13, wherein the instructions are further executable by the processor to cause the apparatus to:
select the mini-slot associated with the time domain interlace based at least in part on a priority of traffic.

15. The apparatus of claim 11, wherein the time domain interlace is associated with a set of mini-slots in the plurality of control resources in a control subchannel.

16. An apparatus for wireless communication at a wireless device, comprising:
a processor;
memory coupled with the processor; and
instructions stored in the memory and executable by the processor to cause the apparatus to:
receive a sidelink control information message in a mini-slot of a control resource associated with a time domain interlace; and
decode the sidelink control information message, wherein the sidelink control information message indicates a data resource for a data transmission based at least in part on the time domain interlace.

17. The apparatus of claim 16, wherein the instructions are further executable by the processor to cause the apparatus to:
receive the data transmission in the data resource indicated by the sidelink control information message.

18. A method for wireless communication at a first wireless device, comprising:
receiving, at the first wireless device, a first sidelink control information message from a second wireless device, wherein the first sidelink control information message indicates a scheduling conflict between a first data transmission of the second wireless device and a second data transmission of the first wireless device; and
transmitting a second sidelink control information message from the first wireless device based at least in part on the scheduling conflict between the first data transmission and the second data transmission, wherein the second sidelink control information message indicates a data resource allocation for the second data transmission that mitigates the scheduling conflict.

19. The method of claim 18, wherein the first sidelink control information message indicates the scheduling conflict further comprises:
decoding the first sidelink control information message, wherein the decoded first sidelink control information message indicates a first data resource for the first data transmission;
comparing the first data resource for the first data transmission with a second data resource for the second data transmission; and
determining that there is at least a partial overlap between the first data resource for the first data transmission and the second data resource for the second data transmission.

20. The method of claim 18, further comprising:
determining a time period between receiving the first sidelink control information message and a transmission time for the second sidelink control information message.

21. The method of claim 20, further comprising:
determining that the time period is greater than a generation time for generating the second sidelink control information message based at least in part on a comparison of the time period with a processing time for generating the second sidelink control information message;
selecting a third data resource for the second data transmission based on the second sidelink control information message such that the third data resource for the second data transmission is non-conflicting with a first data resource for the first data transmission; and
generating the second sidelink control information message for the second data transmission based at least in part on the third data resource, wherein the third data resource comprises the data resource allocation.

22. The method of claim 20, further comprising:
determining that the time period is greater than a modification time for modifying the second sidelink control information message based at least in part on a comparison of the time period with a processing time for modifying the second sidelink control information message;
selecting a third data resource for the second data transmission based on the second sidelink control information message such that the third data resource for the second data transmission is non-conflicting with a first data resource for the first data transmission; and
modifying the second sidelink control information message for the second data transmission based at least in part on the third data resource, wherein the third data resource comprises the data resource allocation.

23. The method of claim 20, further comprising:
comparing the time period with a processing time threshold;
determining that the time period is less than the processing time threshold; and
selecting the second sidelink control information message from a set of sidelink control information messages based at least in part on the second sidelink control information message indicating the data resource allocation.

24. The method of claim 20, further comprising:
comparing the time period with a processing time threshold;
determining that the time period is less than the processing time threshold; and
performing a joint resource re-selection for the data resource allocation for the second data transmission.

25. The method of claim 18, further comprising:
generating a set of sidelink control information messages with different data resources; and
selecting the second sidelink control information message from the set of sidelink control information messages based at least in part on the second sidelink control information message indicating the data resource allocation.

26. The method of claim 18, wherein:
the second sidelink control information message is transmitted in a first radio frequency spectrum band and the second data transmission is transmitted in a second radio frequency spectrum band,
the second radio frequency spectrum band is different from the first radio frequency spectrum band.

27. The method of claim 18, wherein the second wireless device has higher priority traffic than the first wireless device.
